(19) United States
(12) Patent Application Publication
(10) Pub. No.: US 2025/0119959 A1
(43) Pub. Date: Apr. 10, 2025

(54) METHODS AND DEVICES FOR INFORMATION TRANSMISSION

(71) Applicant: ZHEJIANG DAHUA TECHNOLOGY CO., LTD., Hangzhou (CN)

(72) Inventor: Wei MENG, Hangzhou (CN)

(73) Assignee: ZHEJIANG DAHUA TECHNOLOGY CO., LTD., Hangzhou (CN)

(21) Appl. No.: 18/981,627

(22) Filed: Dec. 15, 2024

Related U.S. Application Data
(63) Continuation-in-part of application No. PCT/CN2023/074299, filed on Feb. 2, 2023.

(30) Foreign Application Priority Data
Jun. 20, 2022 (CN) 202210699754.5
Jul. 4, 2022 (CN) 202210776475.4

(51) Int. Cl. H04W 76/10; H04W 52/36; H04W 76/25

(52) U.S. Cl. CPC H04W 76/10; H04W 52/367; H04W 76/25

(57) ABSTRACT

The present disclosure relates to the field of wireless communication technology, in particular to methods and devices for information transmission. The method may include operations. A transmission request for requesting a node to perform remote information transmission may be received and whether a node identification in the transmission request matches a preset identification may be determined through a first type of node. In response to determining that the node identification in the transmission request matches the preset identification, the transmission request may be processed through the first type of node. In response to determining that the node identification in the transmission request doesn't match the preset identification, the transmission request may be forwarded to a second type of node through the first type of node, and the transmission request may be processed through the second type of node.

### CROSS-REFERENCE TO RELATED DISCLOSURES

This application is a Continuation-in-part of International Application No. PCT/CN2023/074299, filed on Feb. 2, 2023, which claims priority to Chinese Patent Application No. 202210699754.5, filed on Jun. 20, 2022, and Chinese Patent Application No. 202210776475.4, filed on Jul. 4, 2022, the contents of each of which are incorporated herein by reference.

### TECHNICAL FIELD

The present disclosure generally relates to the technical field of wireless communication, and in particular to methods and devices for information transmission.

### BACKGROUND

In order to ensure the real-time remote transmission of video data streams, single or multiple video monitoring devices in the same area need to keep operating for a long time.

Video monitoring devices generally use a battery power supply, for example, a battery and a solar panel are used to supply power to video monitoring devices. However, the power of the battery is limited and the real-time powers of different devices are different. In addition, factors such as weather conditions and the aging degree of the solar charging module also restrict the effective duration of video streaming, and devices with high-speed transmission capabilities in a video monitoring device have relatively high power consumption. Therefore, how to transmit the video data stream of a video monitoring device and schedule components in the video monitoring device using limited power to extend the effective duration of video streaming is an urgent problem to be solved at present.

To address the problems discussed above, the present disclosure provides a method for information transmission. The method can select a suitable processing strategy according to the actual situation of a video monitoring device, avoid the waste of electricity, and ensure the transmission of key video data.

### SUMMARY

One of the embodiments of the present disclosure may provide a method for information transmission. The method may include the following operations. A transmission request may be received for requesting a node to perform remote information transmission and a node identification in the transmission request matches a preset identification may be determined through a first type of node. In response to determining that the node identification in the transmission request matches the preset identification, the transmission request may be processed through the first type of node. In response to determining that the node identification in the transmission request doesn't match the preset identification, the transmission request may be forwarded to a second type of node through the first type of node, and the transmission request may be processed through the second type of node. In some embodiments, each of the first type of node and the second type of node comprises a high power consumption device in a sleep state and a low power consumption device in a sleep state.

In some embodiments, each of the first type of node and the second type of node may include a high power consumption device in a sleep state and a low power consumption device in a sleep state. In response to determining that the node identification in the transmission request matches the preset identification, the processing the transmission request through the first type of node may include the following operations. The high power consumption device of the first type of node may be switched to an enabled state, and the information transmission may be performed through the high power consumption device of the first type of node. In response to determining that the node identification in the transmission request doesn't match the preset identification, the forwarding the transmission request to a second type of node through the first type of node may include the following operations. The low power consumption device of the first type of node may be switched to an enabled state, and the transmission request may be forwarded to the second type of node through the low power consumption device of the first type of node.

In some embodiments, the high power consumption device of the first type of node may be in a first sleep state, and the low power consumption device of the first type of node may be in a second sleep state. The high power consumption device of the second type of node may be in the second sleep state, and the low power consumption device of the second type of node may be in the first sleep state. A power consumption of each device in the first sleep state may be higher than a power consumption in the second sleep state.

In some embodiments, before the first type of node receives the transmission request, the method may further include the following operations. The low power consumption device of the first type of node may be enabled to receive one or more response messages sent by the second type of node based on a preset rule, wherein the first type of node and the second type of node are nodes in a specified area. In response to determining that an amount of the received one or more response messages and a power consumption of the low power consumption device of the first type of node satisfy a preset condition, the low power consumption device of the first type of node may be switched to the second sleep state.

In some embodiments, the enabling the low power consumption device of the first type of node to receive one or more response messages sent by the second type of node based on a preset rule may include the following operations. The low power consumption device of the first type of node may be enabled based on a sequence including power consumptions of the low power consumption device from small to large. The one or more response messages sent by the second type of node may be received through the low power consumption device of the first type of node.

In some embodiments, the determining that an amount of the received one or more response messages and a power consumption of the low power consumption device of the first type of node satisfy a preset condition may include the following operations. One or more response messages sent by each node in the specified area may be received through the low power consumption device of the first type of node. In response to determining that the power consumption of the low power consumption device of the first type of node is less than the power consumption of the low power consumption device of a competing node, the preset condition is satisfied may be determined, wherein the competing node is a second type of node that receives the one or more response messages sent by each node in the specified area.

In some embodiments, the determining that an amount of the received one or more response messages and a power consumption of the low power consumption device of the first type of node satisfy a preset condition may include the following operations. A highest transmission power of the low power consumption device of the first type of node may be enabled, and the one or more response messages may be received through the low power consumption device with the highest transmission power, and a first amount of the received one or more response messages may be determined. For each second type of node, a second amount of one or more response messages received by the second type of node may be obtained by enabling the low power consumption device of the second type of node with the highest transmission power. In response to determining that the first amount is greater than the second amount of each second type of node, the preset condition is satisfied may be determined.

In some embodiments, the first type of node and the second type of node may be nodes in a specified area, the first type of node may include a plurality of first type of nodes, each of the plurality of first type of nodes may be configured to receive the one or more response messages sent by each second type of node through their respective low power consumption devices. A total power consumption of the lower power consumption devices of the plurality of first type of nodes may be minimized.

In some embodiments, the transmission request may be configured to transmit video data. Each of the first type of node and the second type of node may include a transmission device, and the processing the transmission request may include the following operations. The video data to be transmitted and a current remaining power of the transmission device may be obtained, wherein the video data to be transmitted includes a frame taken by the transmission device. An analysis result of the video data may be obtained by analyzing the video data through the transmission device. The video data may be transmitted based on the current remaining power and the analysis result.

In some embodiments, the transmitting the video data based on the current remaining power and the analysis result may include the following operations. The video data may be transmitted when the analysis result indicates that the video data has a high-priority, and the current remaining power of the transmission device may satisfy the condition for transmitting the video data. Or the video data may be transmitted based on the current remaining power of the transmission device when the analysis result indicates that the video data has a normal priority.

In some embodiments, the transmitting the video data based on the current remaining power of the transmission device may include the following operations. The video data may be transmitted when the current remaining power of the transmission device is greater than or equal to a first preset threshold. The video data may be transmitted based on an average power consumption efficiency of a cellular module of the transmission device when the current remaining power of the transmission device is less than the first preset threshold and greater than or equal to a second preset threshold, wherein the average power consumption efficiency is an amount of data transmitted by the cellular module with a unit transmission power in a unit time. The video data may be stored in a storage module when the current remaining power of the transmission device is less than the second preset threshold.

In some embodiments, the transmitting the video data based on an average power consumption efficiency of a cellular module in the transmission device may include the following operations. The video data may be transmitted when the average power consumption efficiency is greater than or equal to a preset power consumption efficiency threshold. The video data may be stored in the storage module when the average power consumption efficiency is less than the preset power consumption efficiency threshold.

In some embodiments, after storing the video data in the storage module, the method may further include the following operations. A heartbeat command may be sent to a remote platform every predetermined period to keep a heartbeat keep-alive with the remote platform. During the heartbeat keep-alive with the remote platform, the transmission device may be charged through a charging module of the transmission device to obtain the current remaining power of the transmission device after charging. The video data may be transmitted based on the current remaining power of the transmission device after charging.

In some embodiments, the transmitting the video data based on the current remaining power of the transmission device after charging may include the following operations. The video data may be transmitted when the current remaining power of the transmission device after charging is greater than or equal to the first preset threshold. Or the average power consumption efficiency of the cellular module may be detected when the current remaining power of the transmission device after charging is less than the first preset threshold and a power consumption detection time of the cellular module is reached. The video data may be transmitted when the average power consumption efficiency of the cellular module is greater than or equal to the preset power consumption efficiency threshold.

In some embodiments, the transmitting the video data based on the current remaining power and the analysis result may include the following operations. A key frame image of the video data may be transmitted when the analysis result indicates that the video data has a high-priority, and the current remaining power of the transmission device doesn't satisfy the condition for transmitting the video data but satisfies the condition for transmitting the key frame image.

In some embodiments, the transmitting the video data based on the current remaining power and the analysis result may include the following operations. The video data may be transmitted to a capable node through a low power consumption device when the analysis result indicates that the video data has a high-priority, and the current remaining power of the transmission device doesn't satisfy the condition for transmitting the video data.

In some embodiments, the capable node may be identified based on its average power consumption and remaining power.

One of the embodiments of the present disclosure may provide a device for information transmission. The device may include a request receiving module, a request processing module and a request forwarding module. The request receiving module may be configured to receive a transmission request for requesting a node to perform remote information transmission, and determine whether a node identification in the transmission request matches a preset identification through a first type of node. The request processing module may be configured to in response to determining that the node identification in the transmission request matches the preset identification, process the transmission request through the first type of node. The request forwarding module may be configured to in response to determining that the node identification in the transmission request doesn't match the preset identification, forward the transmission request to a second type of node through the first type of node, and process the transmission request through the second type of node.

One of the embodiments of the present disclosure may provide an electronic device. The electronic device may include a memory and a processor, wherein the memory is configured to store a computer program. When the processor is configured to execute the computer program stored in the memory, the above method for information transmission may be implemented.

One of the embodiments of the present disclosure may provide a computer-readable storage medium, wherein a computer program is stored in the computer-readable storage medium, and when the computer program is executed by a processor, the above method for information transmission may be implemented.

One of the embodiments of the present disclosure may provide a method for information transmission. The method may include the following operations. A transmission request may be received for requesting a node to perform remote information transmission and a node identification in the transmission request matches a preset identification may be determined through a first type of node. Each of the first type of node and a second type of node may include a high power consumption device in a sleep state and a low power consumption device in a sleep state. In response to determining that the node identification in the transmission request matches the preset identification, the high power consumption device of the first type of node may be switched to an enabled state, and the information transmission may be performed through the high power consumption device of the first type of node. In response to determining that the node identification in the transmission request doesn't match the preset identification, the low power consumption device of the first type of node may be switched to the enabled state, and the transmission request may be forwarded to the second type of node through the low power consumption device of the first type of node.

One of the embodiments of the present disclosure may provide a device for information transmission. The device may include a judgment module, a transmission module, and a forwarding module. The judgment module may be configured to receive a transmission request for requesting a node to perform remote information transmission and determine whether a node identification in the transmission request matches a preset identification through a first type of node. Each of the first type of node and a second type of node may include a high power consumption device in a sleep state and a low power consumption device in a sleep state. The transmission module may be configured to in response to determining that the node identification in the transmission request matches the preset identification, switch the high power consumption device of the first type of node to an enabled state, and perform the information transmission through the high power consumption device of the first type of node. The forwarding module may be configured to in response to determining that the node identification in the transmission request doesn't match the preset identification, switch the low power consumption device of the first type of node to the enabled state, and forward the transmission request to the second type of node through the low power consumption device of the first type of node.

One of the embodiments of the present disclosure may provide a electronic device. The electronic device may include a memory and a processor. The memory may be configured to store a computer program. The processor may be configured to implement the above method for information transmission when the computer program stored on the memory is executed.

One of the embodiments of the present disclosure may provide a computer-readable storage medium, wherein a computer program is stored in the computer-readable storage medium, and when the computer program is executed by a processor, the above method for information transmission may be implemented.

One of the embodiments of the present disclosure may provide a video data transmission method. The video data transmission method may include the following operations. Video data to be transmitted and a current remaining power of a transmission device may be obtained, wherein the video data to be transmitted includes a frame taken by the transmission device. An analysis result of the video data may be obtained by analyzing the video data through the transmission device. The video data may be transmitted based on the current remaining power and the analysis result.

One of the embodiments of the present disclosure may provide a video data transmission device. The video data transmission device may be configured to transmit the video data using the video data transmission method according to the video data transmission method. The video data transmission device may include an image acquisition module, a battery monitoring module, a smart detection module, a processing module, a cellular module, a low-power consumption micro-control unit, and a storage module. The image acquisition module may be configured to obtain the video data. The battery monitoring module may be configured to detect the current remaining power of the transmission device. The smart detection module may be configured to analyze the video data to obtain the analysis result of the video data; a processing module configured to transmit the video data based on the analysis result and the current remaining power of the transmission device. The cellular module may be configured to transmit the video data to a remote platform. The low-power consumption micro-control unit may be configured to control the cellular module and the remote platform to keep a heartbeat keep-alive. The storage module may be configured to store the video data.

One of the embodiments of the present disclosure may provide a video data transmission device. The video data transmission device may be configured to transmit video data using the video data transmission method. The video data transmission device may include an acquisition module, an analysis module and a transmission module. The acquisition module may be configured to obtain the video data to be transmitted and the current remaining power of the transmission device, wherein the video data to be transmitted includes a frame taken by the transmission device. The analysis module may be configured to obtain the analysis result of the video data by analyzing the video data through the transmission device. The transmission module may be configured to transmit the video data based on the current remaining power and the analysis result.

One of the embodiments of the present disclosure may provide a computer-readable storage medium, wherein a computer program is stored in the computer-readable storage medium, when the computer program is executed by a processor, the above method for information transmission may be implemented.

One of the embodiments of the present disclosure may provide an electronic device. The electronic device may include a memory and a processor, wherein a computer program is stored in the memory, and the processor may be configured to run the computer program to perform the above method for information transmission.

Additional features will be set forth in part in the description which follows, and in part will become apparent to those skilled in the art upon examination of the following and the accompanying drawings or may be learned by the production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure may be further illustrated in the form of exemplary embodiments, and these exemplary embodiments may be described in detail by means of the accompanying drawings. These embodiments are not limiting, and in these embodiments, the same number indicates the same structure, wherein:

FIG. 1 is a schematic diagram illustrating an application scenario of an information transmission system according to some embodiments of the present disclosure;

FIG. 2 is a schematic diagram illustrating an exemplary node according to some embodiments of the present disclosure;

FIG. 3 is an exemplary flowchart illustrating a method for information transmission according to some embodiments of the present disclosure;

FIG. 4a is a schematic diagram illustrating an exemplary structure of a first type of node in a normal mode according to some embodiments of the present disclosure;

FIG. 4b is a schematic diagram illustrating an exemplary structure of a second type of node in a normal mode according to some embodiments of the present disclosure;

FIG. 5a is a schematic diagram illustrating an exemplary structure of a first type of node in a low power consumption mode according to some embodiments of the present disclosure;

FIG. 5b is a schematic diagram illustrating an exemplary structure of a second type of node in a low power consumption mode according to some embodiments of the present disclosure;

FIG. 6 is the exemplary flowchart illustrating a method for node classification according to some embodiments of the present disclosure;

FIG. 7 is an exemplary flowchart illustrating a method for information transmission according to some embodiments of the present disclosure;

FIG. 8 is an exemplary flowchart illustrating a method for information transmission in a video monitoring scene according to some embodiments of the present disclosure;

FIG. 9 is a schematic diagram illustrating an exemplary transmission device according to some embodiments of the present disclosure;

FIG. 10 is an exemplary flowchart of processing a transmission request according to some embodiments of the present disclosure;

FIG. 11 is a schematic diagram illustrating an application scenario for processing a transmission request according to some embodiments of the present disclosure;

FIGS. 12a and 12b are exemplary flowcharts of processing a transmission request according to some embodiments of the present disclosure;

FIG. 13 is an exemplary block diagram illustrating an information transmission device according to some embodiments of the present disclosure;

FIG. 14 is an exemplary block diagram illustrating an information transmission device according to some embodiments of the present disclosure;

FIG. 15 is an exemplary block diagram illustrating a video data transmission device according to some embodiments of the present disclosure; and

FIG. 16 is a block diagram of a hardware structure of a video data transmission device according to some embodiments of the present disclosure.

### DETAILED DESCRIPTION

In order to more clearly illustrate the technical solutions of the embodiments of the present disclosure, the following will briefly introduce the drawings that demand to be used in the description of the embodiments. Obviously, the drawings in the following description are only some examples or embodiments of the disclosure. For those of ordinary skill in the art, without creative work, the disclosure may be applied to other similar scenarios according to these drawings. Unless it is obvious from the language environment or otherwise stated, the same reference numbers in the drawings represent the same structure or operation.

It should be understood that the “system,” “device,” “unit” and/or “module” used herein is a method for distinguishing different components, elements, parts, portions, or assemblies of different levels. However, if other words may achieve the same purpose, the words may be replaced by other expressions.

As shown in the present disclosure and the claims, unless the context clearly suggests exceptional circumstances, the words “a,” “an,” and/or “the” do not only specifically refer to the singular form, but further include the plural form; the plural form may be intended to include the singular form as well. Generally speaking, the terms “including,” “includes,” “include,” “comprise,” “comprises,” and “comprising,” only suggest that the operations and/or elements that have been clearly identified are included, but these operations and/or elements do not constitute an exclusive list, and the method, system, or device may further include other operations or elements.

Flowcharts are used in the present disclosure to describe operations performed by a system according to an embodiment of the present disclosure. It should be understood that the preceding or following operations are not necessarily performed in the exact order. Instead, the various operations may be processed in reverse order or simultaneously. Further, other operations may be added to these procedures, or an operation or operations may be removed from these procedures.

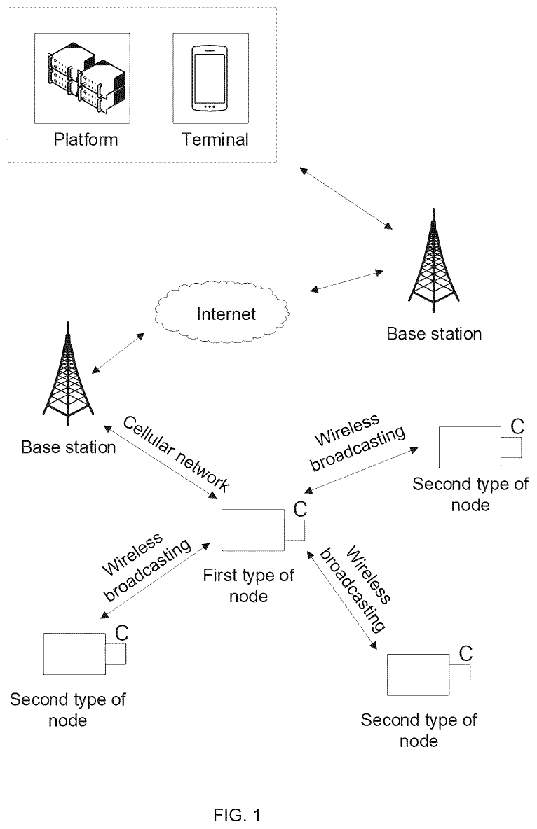

FIG. 1 is a schematic diagram illustrating an application scenario of an information transmission system according to some embodiments of the present disclosure.

The information transmission system may be used for video recording and monitoring. The information transmission system may include a plurality of nodes. The nodes may be divided into two types. The first type of node may communicate with remote platforms and/or terminal devices through wireless networks (e.g., cellular networks), and the second type of node may communicate with the first type of node through wireless broadcasting. It is worth noting that the technical solutions provided in the embodiments of the present disclosure may further be applied in other remote communication application scenarios, which is not elaborated on here.

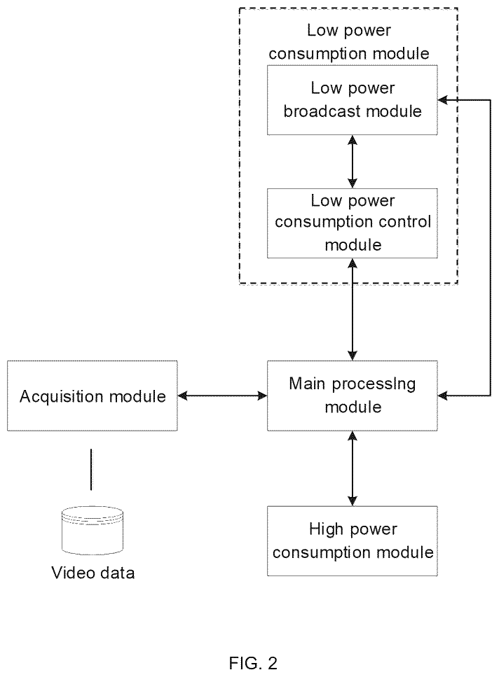

FIG. 2 is a schematic diagram illustrating an exemplary node according to some embodiments of the present disclosure. As shown in FIG. 2, each node of the first type of node and the second type of node may include a high power consumption module, a low power consumption module, an acquisition module, and a main processing module.

The high power consumption module may be configured for high speed information transmission, and the high power consumption module may be a cellular module. Specifically, image information or video information collected by the acquisition module may be remotely transmitted, or a transmission request for remote information transmission may be received. The high power consumption module may include a high power consumption device, such as a Wi-Fi device, a 4G technology device, or a 5G technology device.

The low power consumption module may be configured to broadcast information, and the power consumed by the low power consumption module is less than the power consumed by the high power consumption module. Optionally, the low power consumption module may further include a low power consumption control module and a low power consumption broadcast module. The low power consumption control module may be configured to control the low power consumption broadcast module to implement a heartbeat keep-alive function when the low power consumption broadcast module is in a low power consumption mode. The heartbeat keep-alive may adopt a heartbeat mechanism, which is used to send a custom structure (heartbeat packet) regularly (e.g., every 10 seconds, 30 seconds, or 1 minute, etc.) to let the receiver know that it is still “alive” to ensure the effective connection. The low power consumption broadcast module may be configured to broadcast information. The low power consumption broadcast module may include a low power consumption device, such as one or more of a Bluetooth low energy (BLE) device, a ZigBee (Zigbee Protocol) device, a narrowband internet of things (NB-IoT) device, etc. The acquisition module may be configured to collect image information or video information and store the collected information, such as save the collected video information as video data. The acquisition module may include a camera and a sensor. The camera may include a fisheye camera, an infrared camera, a security camera, etc. The sensor may include a charge-coupled device (CCD), a complementary metal oxide semiconductor (CMOS), etc. In addition, the acquisition module may further collect other information based on actual application requirements, such as temperature information, humidity information, or the like. The main processing module may be configured to process information.

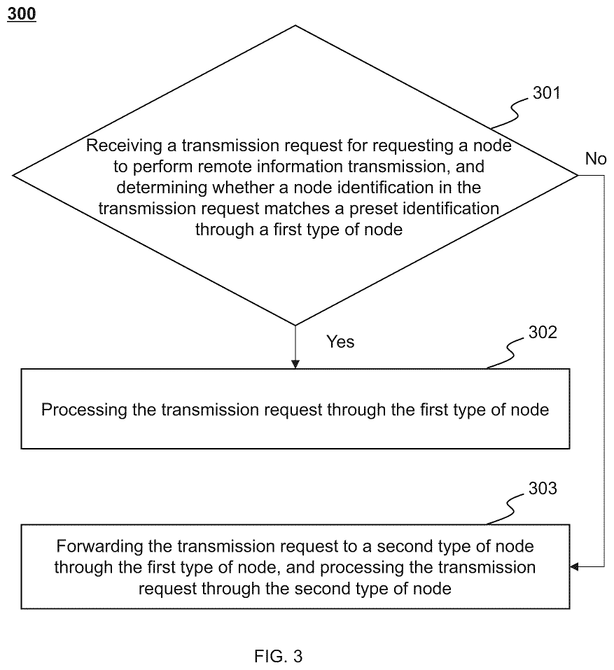

Based on above mentioned first type of node and the second type of node, the embodiments of the present disclosure may provide a method for information transmission. For example, process 300 as shown in FIG. 3 may be performed.

In operation 301: a first type of node may receive a transmission request for requesting a node to perform remote information transmission and determine whether a node identification in the transmission request matches a preset identification. In some embodiments, operation 301 may be performed by the request receiving module 1310.

In some embodiments, the transmission request may be a video transmission request initiated by a platform or a terminal device in FIG. 1 for obtaining real-time image or video stream (video data) collected by a specified node (e.g., a specified first type of node or second type of node). In some embodiments, the transmission request may be used to obtain an image or video stream previously collected and stored locally by the specified node.

In some embodiments, the transmission request may include a node identification, and the node identification may indicate the identity of the specified node that can satisfy the transmission request. In some embodiments, the preset identification may be a node identification of the first type of node that receives the transmission request.

Since the first type of node receiving the above-mentioned transmission request may not be the specified node that can satisfy the transmission request, therefore, the first type of node may need to determine whether the node identification in the transmission request matches (e.g., is the same as) the preset identification. In response to determining that the node identification in the transmission request matches the preset identification, operation 302 may be performed. In response to determining that the node identification in the transmission request doesn't match the preset identification, operation 303 may be performed.

In operation 302, the first type of node may process the transmission request. In some embodiments, operation 302 may be performed by the request processing module 1320.

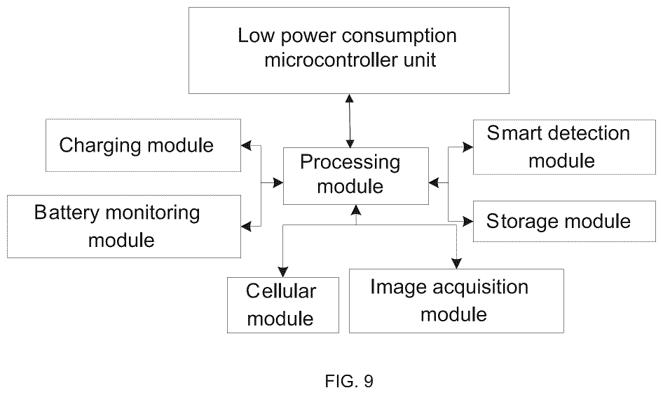

When the node identification in the transmission request matches the preset identification held by the first type of node itself, the first type of node receiving the transmission request is the specified node, and the transmission request may be processed. In some embodiments, processing the transmission request may include transmitting video using direct wireless communication. In some embodiments, the processing of the transmission request may include other processing operations, which will be described in detail in connection with FIG. 9 and its related descriptions.

In operation 303, the first type of node may forward the transmission request to a second type of node, and the second type of node may process the transmission request. In some embodiments, operation 303 may be performed by the request forwarding module 1330.

When the node identification in the transmission request doesn't match the preset identification held by the first type of node, the transmission request may need to be forwarded to the specified node. In some embodiments, the first type of node may directly broadcast the transmission request to all nodes of the second type. In some embodiments, if the ID information of a specified second type of node is included in the transmission request or the first type of node holds the identification of the specified second type of node, the first type of node may directly send the transmission request to the specified second type of node.

In some embodiments, after the second type of node obtains the transmission request forwarded by the first type of node, the transmission request may be processed, and the second type of node may process the transmission request in a manner similar to how the transmission request is processed by the first type of node. More descriptions regarding the processing of the transmission request may be found in the related descriptions of operation 302.

In some embodiments, the enabling and sleeping of each device may be controlled according to actual needs, so as to reduce power consumption.

Specifically, in some embodiments, before operation 301, that is, when no transmission request is received, each first type of node and each second type of node may include a high power consumption device in a sleep state and a low power consumption device in a sleep state.

In some embodiments, in response to determining that the node identification in the transmission request matches the preset identification, processing the transmission request through the first type of node may include the following operations. The high power consumption device of the first type of node may be switched to an enabled state, and the information transmission to the platform or terminal device may be performed through the high power consumption device of the first type of node. In order to perform remote information transmission, the first type of node may switch its own high power consumption device from a first sleep state to an enabled state, and then perform remote information transmission based on the enabled high power consumption device. For the second type of node, the second sleep state of the high power consumption device and the first sleep state of the low power consumption device may be kept, that is, the high power consumption device of the second type of node is not enabled.

In summary, if the request object of the transmission request is the first type of node, only the high power consumption device of the first type node may be switched to the enabled state, and the high power consumption node of the second type node may not be enabled to reduce the power consumption of remote information transmission of multiple nodes. In addition, the low power consumption device of the first type of node may not be enabled, which further reduces the power consumption used by the first type of node in the process of remote information transmission.

In some embodiments, in response to determining that the node identification in the transmission request doesn't match the preset identification, the forwarding the transmission request to the second type of node through the first type of node may include the following operations. The low power consumption device of the first type of node may be switched to the enabled state, and the transmission request may be forwarded to the second type of node through the low power consumption device of the first type of node.

For the second type of node, the low power consumption device of the second type of node may be in the first sleep state, that is, it may periodically accept the transmission request forwarded by the first type of node. In some embodiments, after receiving the transmission request forwarded by the first type of node, the second type of node may further determine whether the node identification in the transmission request matches a preset identification corresponding to the second type of node. In response to determining that the node identification in the transmission request doesn't match the preset identification corresponding to the second type of node, the received transmission request may be ignored. In response to determining that the node identification in the transmission request matches the preset identification corresponding to the second type of node, the remote information transmission may be performed based on the received transmission request.

In order to perform remote information transmission, the second type of node may switch its own high power consumption device from the second sleep state to the enabled state, and then perform remote information transmission based on the enabled high power consumption device. In addition, after forwarding the transmission request, the first type of node may switch the low power consumption device from the enabled state to the second sleep state, and then keep the high power consumption device in the first sleep state.

In summary, if the specified node of the transmission request is a second type of node, only the high power consumption device of the second type of node may be switched to an enabled state, and the high power consumption node of the first type of node may not may be enabled, thereby reducing the power consumption of remote information transmission of the multiple nodes. In addition, the low power consumption device of the second type of node may not be enabled, which further reduce the power consumption used during the remote information transmission performed by the second type of node.

In some embodiments, in order to further prolong the effective time of the video streaming, each node may have working modes, and a suitable working mode may be selected for each node according to the actual situation to reduce power consumption. For any one of the first type of node and the second type of node, the working modes may include a normal mode and a low power consumption mode.

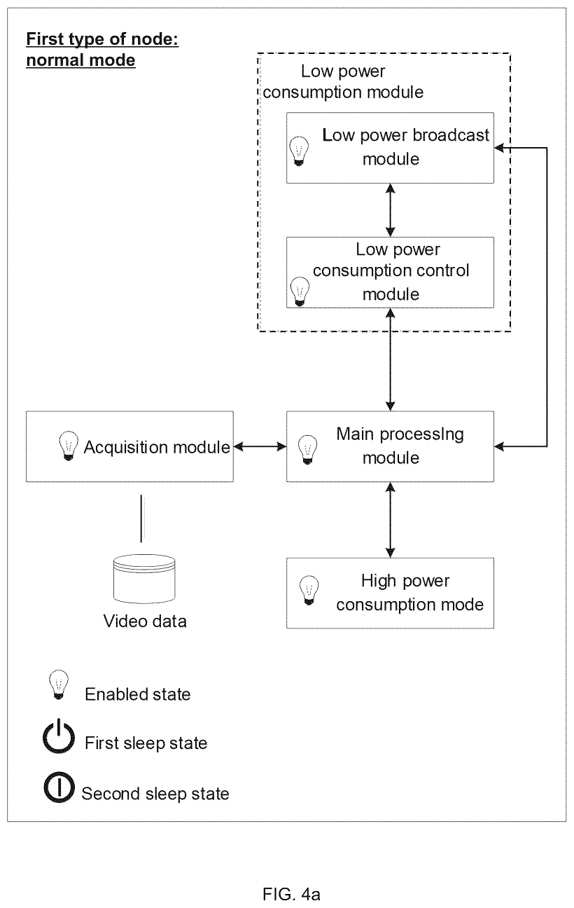

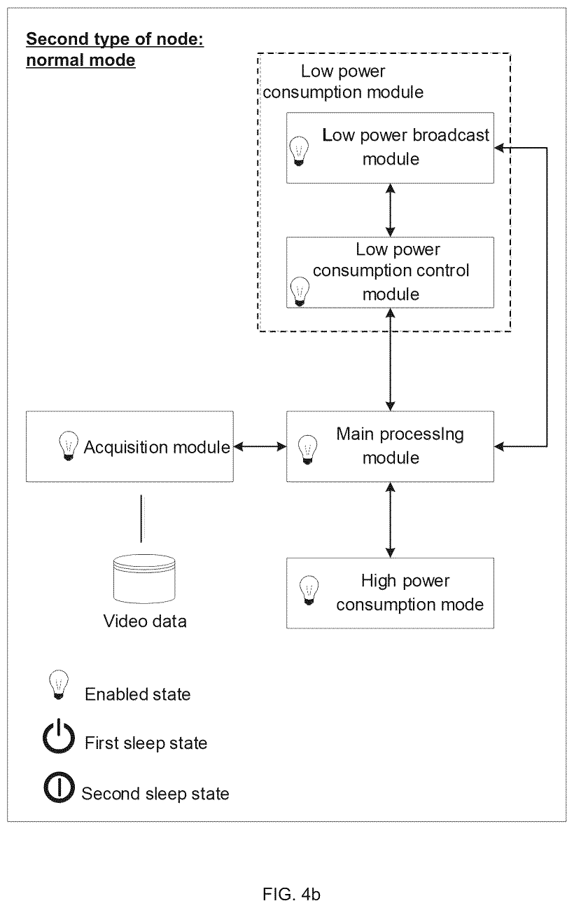

Specifically, workflows of the first type of node and the second type of node in normal mode may be the same. In the normal mode, the node powers up each module, and switches the acquisition module, the high power consumption module, the low power consumption control module, the low power consumption broadcast module, and the main processing module to the enabled state. FIG. 4a illustrates the structure of the first type of node in the normal mode. FIG. 4b illustrates the structure of the second type of node in the normal mode.

In the low power consumption mode, the workflows of the first type of node and the second type of node may be different.

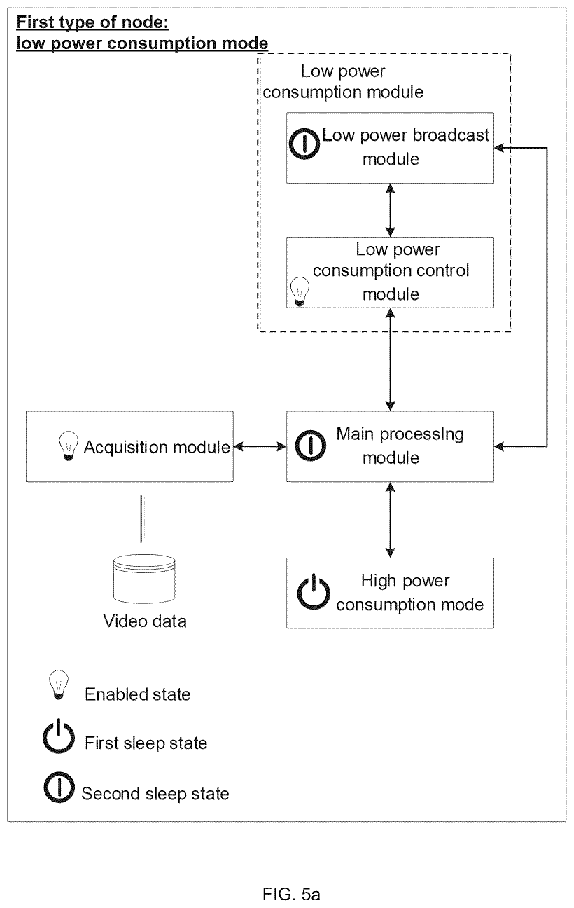

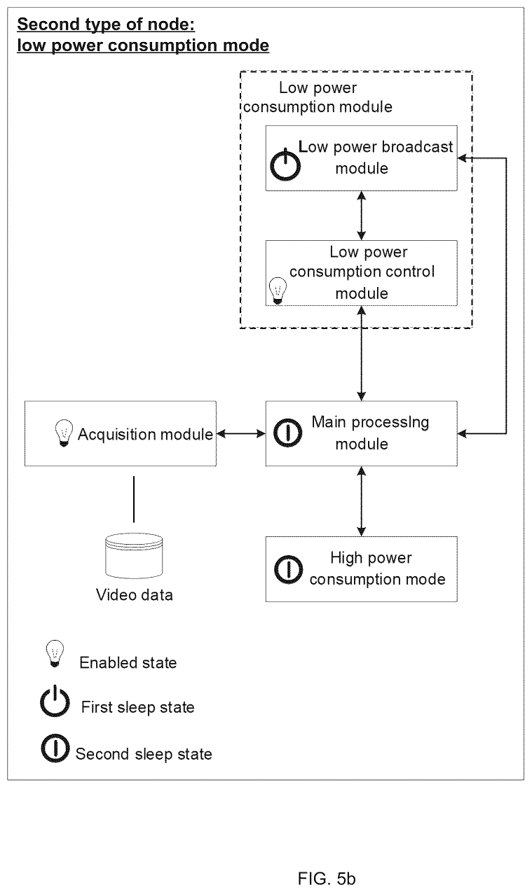

In the low power consumption mode, the first type of node powers on the acquisition module, the high power consumption module, and the low power consumption control module, and powers off the low power consumption broadcast module and the main processing module. As shown in FIG. 5a, the first type of node is in the low power consumption mode may perform the following operations. The acquisition module and the low power consumption control module may be switched to the enabled state, the high power consumption device in the high power consumption module may be switched to the first sleep state, the low power consumption device in the low power consumption broadcast module and the main processing module may be switched to the second sleep state.

In the low power consumption mode, the second type of node powers on the acquisition module, the low power consumption control module, and the low power consumption broadcast module, and powers off the high power consumption module and the main processing module. As shown in FIG. 5b, the second type of node is in the low power consumption mode may perform the following operations. The acquisition module and the low power consumption control module may be switched to the enabled state, the low power consumption device in the low power consumption broadcast module may be switched to the first sleep state, and then the high power consumption module and the main processing module may be switched to the second sleep state.

As used herein, a component in the first sleep state may perform a regular heartbeat keep-alive, and the component in the second sleep state may be powered off, that is, the power consumption in the first sleep state is higher than the power consumption in the second sleep state.

It may be seen that the workflows of the first type of node and the second type of node in the low power consumption mode are different. Specifically, in the low power consumption mode, the first type of node may regularly perform heartbeat keep-alive with a remote platform or a terminal device through a low power consumption device to ensure that the remote platform or the terminal device can obtain streaming data at any time. The streaming data may be image information or video information collected by the acquisition module of the first type of node. In addition, the first type of node may power off the high power consumption device to save power consumption. In the low power consumption mode, the second type of node may regularly perform the heartbeat keep-alive with the first type of node through its low power consumption device to obtain the transmission request forwarded by the first type of node, thereby ensuring the remote platform or the device obtain streaming data at any time after sending the transmission request In addition, the second type of node may power off is high power consumption device to achieve the purpose of saving power consumption. Specifically, in some embodiments, before operation 301, the first type of node may enable its low power consumption device to receive response message(s) sent by the second type of node based on a preset rule. In response to determining that an amount of the received response message(s) and a power consumption of the low power consumption device of the first type of node satisfy a preset condition, the low power consumption device of the first type of node may be switched to the second sleep state.

In some embodiments, the first type of node and the second type of node are nodes in the specified area, and the first type of node is taken as an exemplary execution agent of the above-mentioned operations to illustrate how to determine its own node type to adjust to the workflow when entering the low power consumption mode.

Specifically, when the first type of node receives the response message(s) according to the preset rules, the first type of node may not directly perform the workflow corresponding to the low power consumption mode. Only when it is determined that the amount of received response message(s) and the corresponding power consumption of the low power consumption device satisfy the preset condition, the first type of node may perform the workflow corresponding to the low power consumption mode, and then the low power consumption device of the first type of node may be switched to the second sleep state and the high power consumption device of the first type of node may be switched to the first sleep state.

The preset rule may be a rule that the first type of node enables its low power consumption device based on a power consumption sequence to receive the response message(s) sent by the second type of node. The power consumption sequence may include possible power consumptions of the low power consumption device of the first type of node arranged from small to large. For example, the low power consumption device may first operate with the power consumption of 1 W, and then gradually increase to 10 W according to the power consumption sequence.

The preset condition may be divided into two sub-conditions, the first sub-condition may be that the first type of node receives the largest amount of response messages sent by different nodes, and the second sub-condition may be that the low power consumption device of the first type of node is minimized based on the first sub-condition. The two situations are described hereinafter to describe the preset condition.

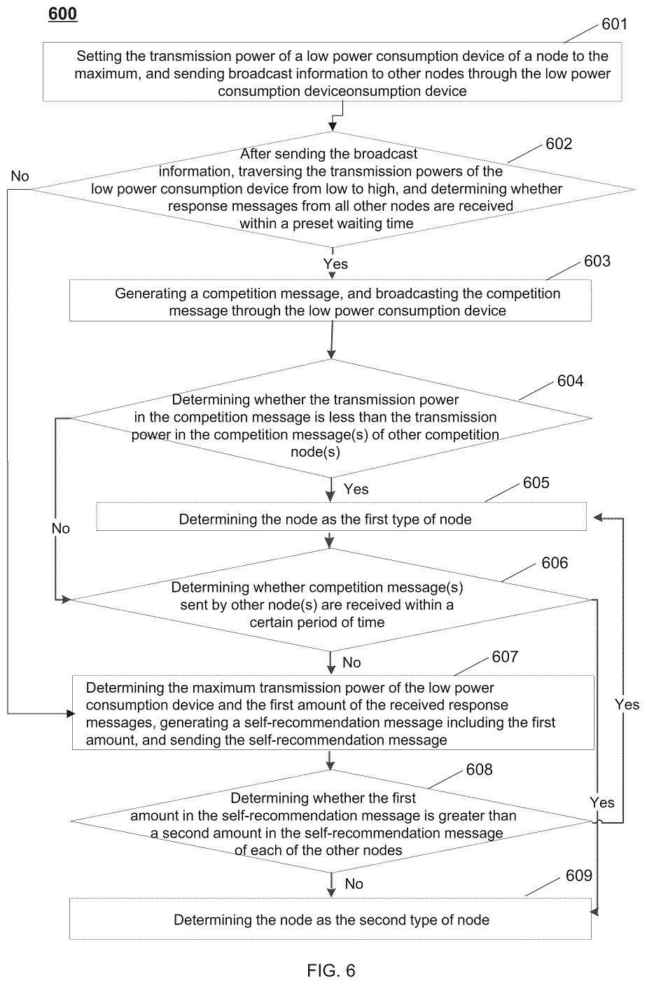

In some embodiments, the first type of node may receive the response message(s) sent by each node in the specified area through its low power consumption device, if the power consumption of the low power consumption device of the first type of node is less than the power consumption of the low power consumption device of a competing node, it may be determined that the preset condition is satisfied. The competing node may be a second type of node that receives the response message(s) sent by each node in the specified area. More descriptions regarding the competing node may be found in FIG. 6 and its related descriptions.

In some other embodiments, a highest transmission power of the low power consumption device of the first type of node may be enabled, and the response message(s) may be received through the low power consumption device with the highest transmission power, and a first amount of the received response message(s) may be determined. Each second type of node may enable its low power consumption device with the highest transmission power, and a second amount of response message(s) received by each second type of node may be obtained. In response to determining that the first amount is greater than the second amount of each second type of node, it may be determined that the preset condition is satisfied.

After starting the workflow corresponding to the low power consumption mode, the first type of node may switch its high power consumption device to the first sleep state, switch its low power consumption device to the second sleep state, and receive the transmission request for requesting remote information transmission sent by the remote platform or the device through its high power consumption device.

In the same way, after starting the workflow corresponding to the low power consumption mode, the second type of node may switch its high power consumption device to the second sleep state, switch its low power consumption device to the first sleep state, and then receive the transmission request forwarded by the first type of node through its low power consumption device.

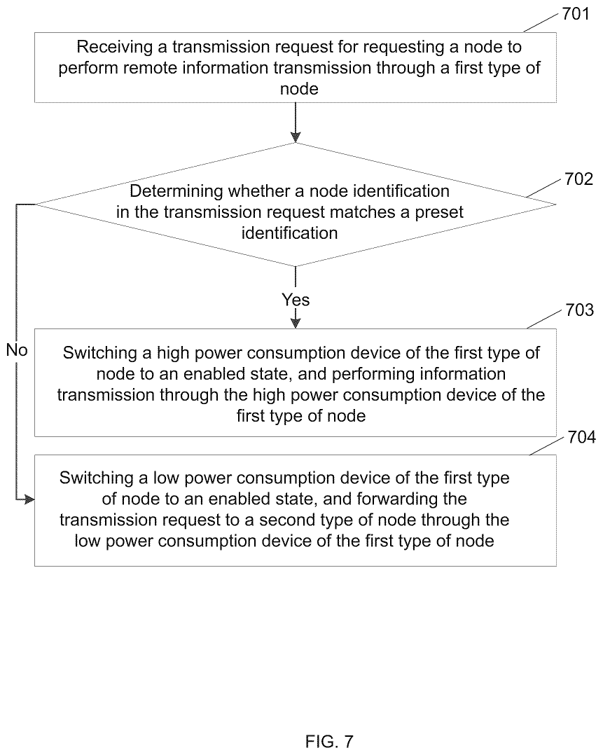

In some embodiments, the embodiments of the present disclosure may further provide a method for information transmission based on the first type of node and the second type of node. As shown in FIG. 7, the method for information transmission may include the following operations.

In operation 701: the first type of node may receive a transmission request for requesting a node to perform remote information transmission.

In some embodiments, the first type of node may receive the transmission request based on a preset rule. The preset rule may be a rule that the first type of node enables its low power consumption device based on a power consumption sequence to receive the response message(s) sent by the second type of node. The power consumption sequence may include possible power consumptions of the low power consumption device of the first type of node arranged from small to large.

In operation 702: the first type of node may determine whether a node identification in the transmission request matches a preset identification.

The first type of node may determine whether the node identification in the transmission request matches with its own preset identification. In response to determining that the node identification in the transmission request matches its own preset identification, operation 703 may be performed. In response to determining that the transmission request doesn't matches with its own preset identification, operation 704 may be performed.

In operation 703: the first type of node may switch the high power consumption device of the first type of node to an enabled state, and perform information transmission through the high power consumption device of the first type of node.

In operation 704: the first type of node may switch the low power consumption device of the first type of node to an enabled state, and forward the transmission request to a second type of node.

The method for node classification may filter out the first type of node whose low power consumption device can cover all nodes in a specified area with the lowest transmission power. Using other nodes as the second type of node, and using the first type of node to represent all the second type of node can achieve the purpose of reducing the power consumption of remote information transmission.

Further, if the above-mentioned first type of node cannot be screened out, then the low power consumption device of each node may be enabled based on its highest transmission power to cover the nodes in the specified area, and the node that covers the most nodes in the specified area may be selected as the first type of node. For example, there are 10 nodes in the specified area, and each of the 10 nodes may enable its low power consumption device to operate in the highest transmission power. Among the 10 nodes, node 1 covers 7 nodes in the specified area, and no node covers 8 nodes or more than 8 nodes in the specified area, then node 1 may be regarded as the first type of node. Optionally, for the remaining 2 nodes not covered by node 1 in the specified area, a first type of node may be filtered out among the 2 nodes using similar methods. In this way, the full coverage of all the second type of nodes in the specified area by the first type of node may be guaranteed, thereby ensuring the reliability of remote information transmission. In addition, all the nodes of the second type may be represented by the first type of node, which may further achieve the purpose of reducing the power consumption of remote information transmission.

In some embodiments, the first type of node and the second type of node are nodes in a specified area, and the first type of node may include one or more nodes. In order to optimize the power consumption of the nodes in the area, the first type of node and the second type of node may need to satisfy the following conditions. One or more of the first type of node can receive the response message(s) sent by each second type of node through their low power consumption devices. The total power consumption of the one or more of the first type of the node receiving the response message(s) sent by each second type of node through the low power consumption devices is the lowest.

In some embodiments, if there are multiple first type of nodes, each first type of node may be wirelessly connected to some second type of nodes to receive messages, and the multiple first type of nodes jointly realize receiving the response message sent by each of the second type of node. For example, taking 2 first type of nodes as an example, if there are 10 second type of nodes in the specified area, each first type of node may be connected to 5 second type of nodes according to the actual situation, or 1 first type of node may be connected with 3 second type of nodes, another first type of node may be connected with other 7 second type of nodes, etc., so that the first type of nodes may receive the response message(s) sent by each second type of node through the low power consumption device.

In some embodiments, the one or more second type of nodes wirelessly connected to each of the 2 first type of nodes in the above-mentioned example may be determined based on the lowest total power consumption of the low power consumption device of the first type of node for receiving the response message sent by each of the second type of node. In some embodiments, test message(s) may be sent by each second type of node, the actual power consumption each second type of node may be calculated, and the first type of node that receives a message each second type of node may be determined.

Further, a method for information transmission provided by the embodiments of the present disclosure may be described in detail below in combination with specific application scenarios.

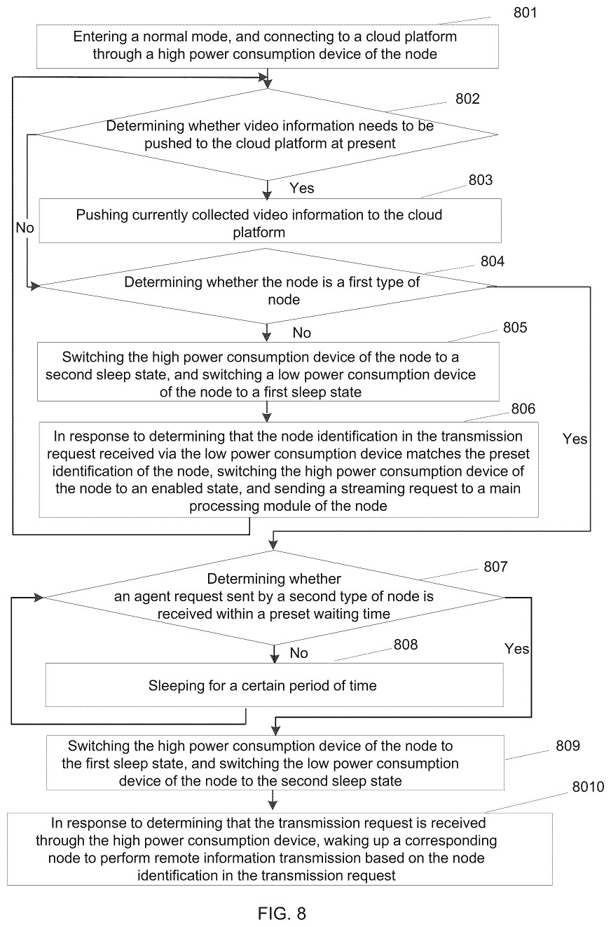

FIG. 8 illustrates a method for information transmission under a video monitoring scene. The nodes may push video information to a cloud platform as required, the method may be performed by any node, and the implementation of the process 600 by a node is described below.

In operation 801: a node may enter a normal mode, and connect to a cloud platform through a high power consumption device of the node.

The node may power up each module, and switch an acquisition module, a high power consumption module, a low power consumption control module, a low power consumption broadcast module, and a main processing module to an enabled state to enter the normal mode. Then the node may be connected to the remote cloud platform through the high power consumption device in the high power consumption module, and realize a login operation on the cloud platform.

In operation 802: the node may determine whether video information needs to be pushed to the cloud platform at present.

The video information may be video information collected by the acquisition module, and pushing the video information refers to sending the video information collected in real-time to the cloud platform.

The node may determine whether the video information needs to be pushed to the cloud platform at present. In response to determining that the video information needs to be pushed to the cloud platform at present, operation 803 may be performed. In response to determining that the video information doesn't need to be pushed to the cloud platform at present, operation 804 may be performed.

In operation 803: the node may push currently collected video information to the cloud platform.

In some embodiments of the present disclosure, a time period may further be preset, that is, the video information collected in the preset time period may be pushed to the cloud platform, or the video information collected in the current time period may be pushed to the cloud platform.

In operation 804: the node may determine whether the node is a first type of node.

More descriptions regarding the determination of whether a node is a first type of node may be found in the above-mentioned method for node classification. The first type of node may be configured to receive a transmission request sent by the cloud platform. The second type of node may be configured to receive a transmission request forwarded by the first type of node.

The node may determine whether the node itself is a first type of node. In response to determining that the node isn't the first type of node, operation 805 may be performed. In response to determining that the node is the first type of node, operation 807 may be performed.

In operation 805: the node may switch the high power consumption device of the node to the second sleep state, and switch the low power consumption device of the node to the first sleep state.

In response to determining that the node is the second type of node, then login information for logging into the cloud platform may be sent to the first type of node through the low power consumption device of the node. Then the high power consumption module and the main processing module of the node may be powered off through the low power consumption control module, that is, the high power consumption device in the high power consumption module may be switched to the second sleep state. Then the low power consumption device in the low power consumption broadcast module of the node may be switched to the first sleep state through the low power consumption control module to minimize the power consumption of the node on the basis that the node can receive transmission requests.

Optionally, the low power consumption device in the first sleep state may periodically receive a transmission request sent by the first type of node, and the regular time may be set according to actual application requirements, such as 2 s.

In operation 806: in response to determining that the node identification in the transmission request received via the low power consumption device matches the preset identification of the node, the high power consumption device of the node may be switched to an enabled state, and a streaming request may be sent to the main processing module of the node.

In response to determining that the transmission request is received by the low power consumption device, and the node identification in the transmission request matches the preset identification of the node, the low power consumption control module may power on the main processing module, and the high power consumption module of the node, that is, the high power consumption device in the high power consumption module may be switched to an enabled state, and a streaming request may be sent to the main processing module, and then operation 802 may repeatedly be performed. The streaming request may represent that video information needs to be pushed to the cloud platform.

In operation 807: the node may determine whether an agent request sent by the second type of node is received within a preset waiting time.

The first type of node may be configured to receive the transmission request sent by the cloud platform. The second type of node may be configured to receive the transmission request forwarded by the first type of node. That is, the second type of node cannot receive the transmission request sent by the cloud platform, but the first type of node acts as an intermediate object for receiving the transmission request. That is, after determining the node is a first type of node, it is necessary to obtain the agent request sent by each second type of node, so that the node can become the agent of each second type of node.

Therefore, the node may further need to determine whether an agent request sent by the second type of node is received within the preset waiting time. In response to determining that no agent request sent by the second type of node is received within the preset waiting time, operation 808 may be performed. In response to determining that an agent request sent by the second type of node is received within the preset waiting time, operation 809 may be performed.

In operation 808: the node may sleep for a certain period of time.

After the node sleeps for a certain period of time, operation 807 may be repeatedly performed.

In operation 809: the node may switch the high power consumption device of the node to the first sleep state, and switch the low power consumption device of the node to the second sleep state.

In response to determining that the node is the first type of node, then its own login information and the login information of the agented second type of node may be summarized, and the aggregated login information may be transmitted to the low power consumption control module. Then the low power consumption control module may take over the high power consumption module and the low power consumption broadcast module, and at the same time, and the low power consumption module may power off the main processing module. Then the login information may be sent to the cloud platform through the high power consumption module to complete the registration on the cloud platform.

After completing the registration, the low power consumption broadcast module may be powered off by the low power consumption control module, that is, the low power consumption device in the low power consumption control module may be switched to the second sleep state. The high power consumption device in the high power consumption module may be switched to the first sleep state through the low power consumption control module, that is, the transmission request sent by the cloud platform may be received based on the high power consumption device in the high power consumption module. At the same time, a heartbeat packet may be periodically sent to the cloud platform to maintain the connection of the cellular link based on the high power consumption device in the high power consumption module.

In operation 8010: in response to determining that the transmission request is received through the high power consumption device, the node may wake up a corresponding node to perform remote information transmission based on the node identification in the transmission request.

In response to determining that the transmission request is received through the high power consumption device, the node may determine whether the node identification in the transmission request matches its preset identification. In response to determining that the node identification in the transmission request matches its preset identification, the high power consumption device of the node may be switch from the first sleep state to an enabled state, and the video information may be transmitted to the cloud platform through the enabled high power consumption device. In response to determining that the node identification in the transmission request doesn't match the preset identification of the node, the transmission request may be transmitted to the second type of node by broadcasting, so that the second type of node matching the node identification enables its high power consumption to transmit video information to the cloud platform.

In summary, in the low power consumption mode, only the high power consumption device of the first type of node is in the first sleep state to receive the transmission request sent by the remote platform, and the low power consumption device of the first type of node is in the second sleep state, that is, there is no power consumption of the low power consumption device of the first type of node. The second type of node may only have a low power consumption device in the first sleep state to receive the transmission request forwarded by the first type of node, and the high power consumption device of the second type of node is in the second sleep state, that is, there is no power consumption of the high power consumption device of the second type of node. Through such a method, unnecessary waste of power consumption of each node in the low power consumption mode may be effectively reduced, and the design based on the first type of node and the second type of node may timely control each node to receive the transmission request for information transmission.

Further, the first type of node and the second type of node may be classified according to the transmission power of their low power consumption devices and their amounts of covered nodes. Nodes having a low power consumption device with lower transmission power and covering more nodes may be regarded as the first type of node, and the remaining nodes may be regarded as the second type of node. The low power consumption device of the first type of node may use wireless broadcasting that can achieve low power consumption, which may further reduce power consumption compared to fixed transmission power.

In some embodiments, the first type of node and the second type of node are nodes within a specified area, and the first type of node and the second type of node may be determined by: inputting an agent node graph into a node classification model to obtain a node classification result; determining the first type of node and the second type of node based on the node classification result.

The agent node graph includes graph nodes and edges between the graph nodes. Each the graph node represents a node in the specified area, and the attribute of each the graph node includes features of the corresponding node, for example, a node location (e.g., latitude and longitude), a node power consumption, and a remaining power of its corresponding node. In some embodiments, the node power consumption may include a power consumption of a low power consumption device and a power consumption of a high power consumption device corresponding to the node.

An edge connects two graph nodes in the agent node graph, and the attribute of the edge represent a distance between nodes corresponding to the two connected graph nodes. In some embodiments, the attribute of the edge may also include an attenuation factor, which represents the degree of signal interference between the two nodes connected by the edge. The attenuation factor may be determined by geography environment around the nodes connected by the edge. For example, the attenuation factor may be a value between 0 and 1, with a lower value indicating higher degree of signal interference and the poorer quality of signal transmission.

The input to the node classification model includes the agent node graph, and the output includes the node classification result. In some embodiments, the node classification result may include one or more nodes in the specified area that are suitable as the first type of node, then other nodes in the specified area may be identified as the second type of node. In some embodiments, the node classification result may include one or more nodes in the specified area that are suitable as the second type of node, then other nodes in the specified area may be identified as the first type of node. In some embodiments, the node classification result may include a category (the first type of node or the second type of node) for each node in the specified area.

The node classification model can be obtained by training an initial model using training samples and training labels. A training sample may include a sample agent node graph, and the corresponding training label may include a sample node classification result corresponding to the sample agent node graph. The sample agent node graph is similar to the agent node graph described above. The sample node classification result is similar to the node classification result described above. In some embodiments, the training samples and training labels may be determined based on historical operation data. Specifically, the training samples may be input into an initial model, a value of a loss function may be determined based on the training labels and predictions output from the initial model, and the initial model may be iteratively updated based on the value of the loss function by gradient descent or other methods. The model training is completed when a preset condition is met, and the trained node classification model is obtained. Exemplary preset conditions include that the loss function converges, the number of iterations reaches a threshold, and so on.

The remaining power of the nodes within the specified area may change, so in some embodiments, an expected endurance time of each first type of node may be determined; an update time of the agent node graph may be determined based on a minimum value of the expected duration of each first type of node; the agent node graph may be updated at the update time, and a updated agent node graph may be input into the node classification model for updating the first type of node and the second type of node.

In some embodiments, an estimated endurance time of the first type of node may be determined based on the remaining power of the first type of node, and the power consumption of the low power consumption device, and the power consumption of the high power consumption device. In some embodiments, the node classification result output by the node classification model may include the estimated endurance time of the first type of node.

The first type of node corresponding to the minimum estimated endurance time may be the first to run out of power, and at that time, the node is no longer suitable to continue as the first type of node. Thus, the minimum value in the estimated endurance times may be used to determine an update time for the agent node graph, and the agent node graph is updated when the update time is reached. Updating the agent node graph may include updating the remaining power corresponding to each node in the agent node graph. After inputting the updated agent node graph into the node classification model again, the node classification model may output an updated node classification result to update the first type of node and the second type of node.

In some embodiments, when a new node joins the specified area, or when charging of a node that has been dropped is completed, the agent node graph may be updated, and the first type of node and the second type of node may be updated based on the updated agent node graph.

By constructing the agent node graph and using the node classification model to determine the first type of node and the second type of node, nodes can be accurately and efficiently categorized according to the distribution of the nodes and the characteristics of the residual power situation, which ensures the reasonableness of the node allocation and saves power. Additionally, the agent node graph can be updated according to the actual situation, so that the node classification result is more in line with the current actual situation.

In some embodiments, when the node is powered by a battery, it may further be necessary to pay attention to factors such as the power of the current node when it cannot be charged immediately or is inconvenient to charge. Therefore, in some embodiments, in addition to the aforementioned considerations based on node power consumption, the process of information transmission may further be determined according to the power of the node or the important program of the video data.

In some embodiments, the first type of node and the second type of node include transmission devices and the transmission devices may be a high power consumption module and/or a low power consumption module in FIG. 2. In some embodiments, the transmission device may further have a structure as shown in FIG. 9.

As shown in FIG. 9, the transmission device may include one or more of the following modules. A processing module may be configured to realize the processing of integrated services. For example, the processing module may be configured to transmit video data according to analysis results of video data and the remaining power of the transmission device. An image acquisition module may be configured for image acquisition. The image acquisition module may be an image acquisition device such as a camera, and may be configured to collect video data of a scene. A low power consumption microcontroller unit, also known as a low power consumption MCU module, may be configured to control a cellular module to implement the heartbeat keep-alive function when the transmission device is in a low power consumption mode. The cellular module may be configured to transmit the video data collected by the image acquisition module to the remote platform when the transmission device is in the wake up mode. At the same time, the remote platform may wake up the transmission device through the cellular module. A smart detection module, also known as an Al detection module, may be configured to perform smart image analysis on the video data and analyze whether the video data has a high-priority. A charging module may be configured to charge a battery of the transmission device using solar energy, also known as a solar charging module. A battery monitoring module may be configured to detect the current remaining power of the transmission device in real-time.

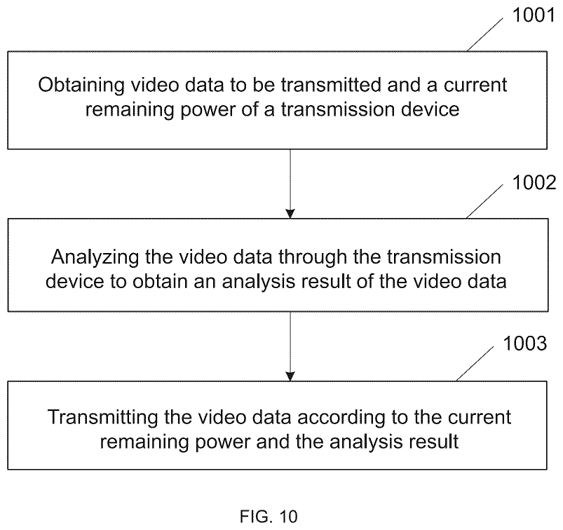

As shown in FIG. 10, in some embodiments, in operation 302 and operation 303, the processing of the transmission request performed by a node (e.g., the first type of node or the second type node) may further include the following operations.

In operation 1001, video data to be transmitted and a current remaining power of the transmission device may be obtained, wherein the video data to be transmitted may include a picture taken by the transmission device.

The video data may include video data collected by the image acquisition module of the transmission device, and/or video data saved locally. The battery monitoring module in above mentioned transmission device may obtain the current remaining power of the transmission device.

In operation 1002, the video data may be analyzed through the transmission device to obtain an analysis result of the video data.

The analysis of the video data may be performed on the video data through the smart detection module in the transmission device. For example, artificial intelligence technology may be used to determine whether the video data contains acts such as arson or theft, or to determine whether there are new people, animals, etc. in the video data. In some embodiments, the analysis result may include but is not limited to the priority of the video data. For example, if the video data includes the aforementioned arson, theft, and other acts, the video data may be identified as having high-priority. When the video data doesn't include movable objects, it may be considered as having normal priority.

In operation 1003, the video data may be transmitted according to the current remaining power and the analysis result.

The analysis result may indicate an immediate transmission of the video data or a later transmission, and in some embodiments, the analysis result may further include the recipient of the video data, etc.

Optionally, the execution subject of the above operations in FIG. 10 may be the transmission device of the video data, or other devices with similar processing capabilities, such as the main processing module in FIG. 2. Alternatively, the above operations in FIG. 10 may be performed by a machine including at least an image acquisition device and a data processing device. The image acquisition device may include a graphics acquisition module such as a camera, and the data processing device may include a computing unit, etc.

In the above operations, the transmission device may transmit the video data based on the current remaining power, and may directly transmit the video data when the current remaining power obtained by the device is relatively sufficient. When the current remaining power is average or insufficient, the video data may be transmitted according to the average power consumption efficiency of the cellular module in the transmission device, so that how to transmit video data may be dynamically adjusted according to the current remaining power of the transmission device, which has a higher utilization rate of the current remaining power of the transmission device. Since the transmission device transmits the video data according to the current remaining power, the transmission device is able to transmit the video data when the power is normal or insufficient, thereby achieving the technical effect of improving the transmission efficiency of the video data. Therefore, the problem of low transmission efficiency of the video data may be solved.

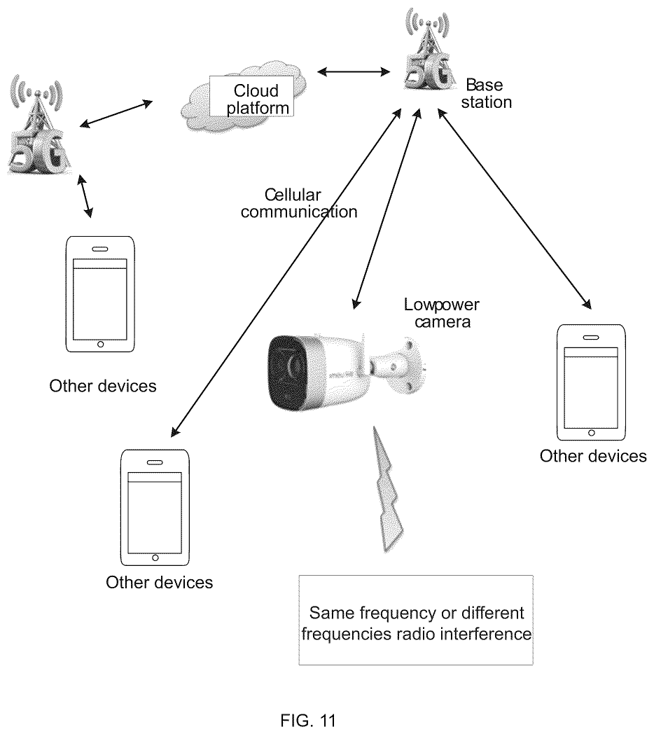

In some embodiments, the above-mentioned process in FIG. 10 may be applied to an exemplary scene shown in FIG. 11. The transmission device sequentially initializes the cellular module, the battery monitoring module, the smart detection module, the low-power consumption micro-control unit, the storage module, and image acquisition module. After the initialization of each module of the transmission device is completed, the transmission device may first log into the cloud platform (also called the remote platform) through the cellular network, and obtain control information from the cloud platform. If it is necessary to push the collected video data or cached video data (which has not been transmitted yet) to the cloud platform at present, a streaming evaluation task may be started.

In some embodiments, the transmitting the video data according to the current remaining power and the analysis result may include the following operations. The video data may be transmitted when the analysis result indicates that the video data has a high-priority, and the current remaining power of the transmission device satisfies a condition for transmitting the video data. The video data may be transmitted based on the current remaining power of the transmission device when the analysis result indicates that the video data has a normal priority.

In some embodiments, the transmission device may first initialize each module after being powered on, for example, the transmission device sequentially initializes the cellular module, the battery monitoring module, the smart detection module, the low-power consumption micro-control unit, the storage module, and the image acquisition module.

In some scenarios of the present disclosure, after initializing each module of the transmission device, the transmission device first may perform a login operation into the cloud platform (also referred to as a remote platform) through the cellular network, and at the same time obtain control information from the cloud platform. If it is necessary to push the collected video data or the cached video data (which has not been transmitted yet) to the cloud platform at present, a streaming evaluation task may be started.

In some embodiments, the above-mentioned transmission device may include two working modes for users to choose, a real-time working mode and a smart working mode. In the real-time working mode, the current remaining power of the transmission device, the power consumption efficiency of the cellular module, etc., may not need to be considered, and video transmission may be started when there is a streaming request of the cloud platform.

In some embodiments, in the smart working mode, the smart analysis may be carried out based on the current remaining power of the transmission device, the power consumption efficiency of the cellular module, and the urgency of the current video data. The smart analysis may include the following operations.

Smart detection may be performed on the current video data to determine whether the current video data includes urgent and important image data. If the video data includes a high-priority behavior such as arson or theft, the transmission device may immediately start transmitting the video data and notify an administrator or user of important emergency information in time.

If the current video data has a normal priority, the current remaining power of the transmission device may be checked at this time. If the current remaining power is sufficient, the current video data may be pushed to the cloud platform, and the transmission device may switch to a sleep state.

In some embodiments, in the smart working mode, transmitting the video data based on the current remaining power of the transmission device and the priority of the video data may improve the utilization rate of the transmission device, and video data having a higher level may be timely transmitted, thereby improving the transmission efficiency of video data. In some embodiments, transmitting the video data according to the current remaining power of the transmission device may include the following operations. The video data may be transmitted when the current remaining power of the transmission device is greater than or equal to a first preset threshold. The video data may be transmitted based on an average power consumption efficiency of the cellular module of the transmission device when the current remaining power of the transmission device is less than the first preset threshold and greater than or equal to a second preset threshold. The average power consumption efficiency may be an amount of data transmitted by the cellular module with a unit transmission power in a unit time. The video data may be stored in the storage module when the current remaining power of the transmission device is less than the second preset threshold.

In some embodiments, the above-mentioned first preset threshold and the second preset threshold may be set according to actual conditions, and the first preset threshold may be greater than the second preset threshold. When the current remaining power is greater than or equal to the first preset threshold, the remaining power of the transmission device is sufficient, and the video data is directly transmitted.

When the current remaining power of the transmission device is less than the first preset threshold and greater than or equal to the second preset threshold, the current remaining power of the transmission device may be in a normal or insufficient state. If the current video data has a normal priority, the pre-pull streaming mode may be started, and the average power consumption efficiency of the current cellular module may be determined. The average power consumption efficiency may be the amount of data that a device sends when the transmission power is 1 dbm per unit time (1 second). The average power consumption efficiency may be calculated continuously for 10 seconds, and the average power consumption efficiency is denoted as M hereinafter. A preset power consumption efficiency threshold P may be a test experience value, which indicates an amount of data that can be sent in 1 second when the current network signal is good and the base station resources are sufficient.

In some embodiments, the transmitting the video data according to the average power consumption efficiency of the cellular module in the transmission device may include the following operations. The video data may be transmitted when the average power consumption efficiency is greater than or equal to the preset power consumption efficiency threshold. The video data may be stored in the storage module when the average power consumption efficiency is less than the preset power consumption efficiency threshold.

In some embodiments, when M>=p, it means that the current cellular module has a high transmission efficiency, the network signal may be good in the current transmission device, and the base station resources are sufficient, and there are enough wireless resources for the device to perform efficient data transmission. At this time, even if the power of the transmission device is insufficient, the transmission device may quickly send video data, and then enter a low power consumption state. If M<P and the current remaining power is insufficient, the current video data may be cached into the storage module, and the transmission of the current video data may be started until the power becomes sufficient or the environmental quality of the cellular module is improved.

In some embodiments, after storing the video data in the storage module, the method may further include the following operations. A heartbeat command may be sent to a remote platform every predetermined period to keep a heartbeat keep-alive with the remote platform. During the heartbeat keep-alive with the remote platform, the transmission device may be charged through the charging module of the transmission device, and the current remaining power of the transmission device after charging may be obtained. The video data may be transmitted based on the current remaining power of the transmission device after charging. More descriptions regarding the heartbeat keep-alive may be found in FIG. 2 and its related descriptions.

In some embodiments, after the transmission device enters the low power consumption state, the cellular module may be taken over by a low-power consumption micro-control unit (e.g., a low power consumption MCU), and the low power consumption MCU powers off the processing module to allow the transmission device to enter a very low power state.

In order to ensure that the remote platform controls the transmission device at any time and video data to be transmitted can be sent out in time, the low power consumption MCU and the cellular module may wake up regularly and perform heartbeat keep-alive action with the remote platform, such as once a minute.

During each heartbeat keep-alive period, the charging module may charge the transmission device, and the low power consumption MCU may check whether there is video data to be transmitted at present. If there is video data to be transmitted, the current remaining power of the transmission device after charging may be checked, and the video data may be transmitted according to the current remaining power of the transmission device after charging.

In some embodiments, the transmitting the video data based on the current remaining power of the transmission device after charging may include the following operations. The video data may be transmitted when the current remaining power of the transmission device after charging is greater than or equal to the first preset threshold. The average power consumption efficiency of the cellular module may be detected when the current remaining power of the transmission device after charging is less than the first preset threshold and a power consumption detection time of the cellular module is reached. The video data may be transmitted when the average power consumption efficiency of the cellular module is greater than or equal to the preset power consumption efficiency threshold.

In some embodiments, if the charging module has charged the battery of the transmission device to enough power, such as the power level is sufficient (greater than or equal to the first preset threshold), then the processing module may immediately be waked up for video data transmission. If the current remaining power of the transmission device after charging is still insufficient (less than the first preset threshold), and the power consumption detection time of the cellular module has arrived (considering that the power consumption efficiency detection consumes more energy than the keep-alive function, the cycle may be set for a longer time, such as once every 30 minutes or longer), the power consumption efficiency detection of the cellular module may be turned on. The power consumption efficiency of the cellular module changes with changes in the surrounding environment (e.g., the amount of devices connected to the cell and other wireless interference, etc.). Timing and periodic detection may detect changes in the environment of the cellular module in time. When the average power consumption efficiency of the cellular module reaches the specified threshold P, the processing module may be awakened for video data transmission.

As an optional embodiment, if the transmission device is in a low power consumption state, and the transmission device has no video data to be sent, then the transmission device may only periodically perform the keep-alive action with the remote platform and not perform additional actions. When the remote platform has a wake-up command, the transmission device may be woken up for a streaming response.

In some embodiments, the analysis result may indicate that the current video data includes urgent and important image data, that is, the current video data has a high-priority, but when the current remaining power of the transmission device doesn't satisfy the conditions for transmitting the video data, whether the remaining power can transmit a key frame image may be determined. When the current remaining power satisfies the conditions for transmitting the key frame image, the key frame image may be transmitted to notify the administrator or user.

The key frame image may be obtained by the smart detection module based on the video data. For example, the key frame image may be one or more frames of images showing the face or the physical characteristics of an arsonist or a thief obtained from the video data. In some embodiments, the amount of key frame images that can be transmitted may further be determined based on the current remaining power. For example, the priority of multiple key frame images may further be divided, and a high-priority key frame may be transmitted according to the current remaining power.

In some embodiments, the analysis result may indicate that the current video data includes an urgent and important picture, that is, the current video data has a high-priority, but when the current remaining power of the transmission device doesn't satisfy the conditions for transmitting the video data, the video data may be transmitted to capable nodes using the low power consumption device.

Compared with the cellular module, the low power consumption device may consume less power when transmitting the video data, but it cannot directly communicate with the base station. Therefore, it is necessary to use the low power consumption device to transmit the video data to a capable node that also has a low power consumption device, so that capable node may forward the video data to the cloud platform.

In some embodiments, the capable node may be a first type of node or a second type of node. In some embodiments, whether a node is a capable node may be comprehensively determined based on the average power consumption efficiency and the remaining power of the node. More descriptions regarding the average power consumption efficiency and the remaining power of a node may be found elsewhere in this disclosure.

It should be noted that, in some embodiments, the low power consumption device may transmit the key frame image to the capable node.

In order to ensure a better monitoring effect, in the case that the current remaining power of the transmission device doesn't satisfy the conditions for transmitting the video data but satisfies the conditions for transmitting the key frame images, more suitable key frames may be selected for transmission. In some embodiments, transmitting the key frame images by the transmission device may comprise: inputting the video data into a key frame determination model to obtain a plurality of key frame images and an importance factor for each key frame image; sorting the plurality of key frame images according to their importance factors in ascending order to obtain an image sequence.

In some embodiments, the input to the key frame determination model includes video data (e.g., a high-priority video data), and the output includes the plurality of key frame images and an importance factor corresponding to each key frame image. The importance factor indicates the level of importance of the corresponding key frame image.

In some embodiments, similar to the node classification mode, the key frame determination model may be obtained by training samples and training labels. The training samples of the key frame determination model may include sample video data, and the training labels include sample key frame images selected from the sample video data and sample importance factors. The sample video data may be obtained from a historical video, and the training labels may be labeled manually. More descriptions of the model training can be found in the descriptions relating to the node classification model.

In some embodiments, the number of key frame images output by the key frame determination model may be limited, e.g., the key frame determination model may be controlled not to output the key frames with a low importance factor (e.g., less than 0.3) to reduce the number of key frame images.

In some embodiments, an extimated transmission count of frames may be determined based on the current remaining power of the transmission device. Then, based on the relationship between the extimated transmission count of frames and the number of the key frame images, the transmission device is further configured to: in response to determining that the extimated transmission count of frames is greater than the number of the key frame images, transmitting the plurality of key frame images in the image sequence in sequence; in response to determining that the extimated transmission count of frames is less than the number of the key frame images, compressing and transmitting the plurality of key frame images in the image sequence sequentially until power off.

When the extimated transmission count of frames is greater than the number of key frame images, the current transmission device is able to transmit all the key frame images, then key frame images in the image sequence can be transmitted sequentially, i.e., the plurality of key frame images in the image sequence can be transmitted according to the degree of importance of the key frame images, to ensure that the important images are prioritized to be transmitted in case of accidents.

When the extimated transmission count of frames is less than the number of the key frame images, it indicates that the current remaining power is unable to transmit all of the key frame images. At this time, the transmission device can sequentially compress the plurality of key frame images in the image sequence in order to reduce the amount of transmission and reduce the power consumption. At the same time, the transmission device transmits the compressed key frame images sequentially until the power is cut off to ensure that as many key frame images of high importance are sent as possible.

The key frame determination model allows for fast and accurate determination of the key frame image, such that more important key frame images can be transmitted, which significantly improves safety and transmission efficiency.

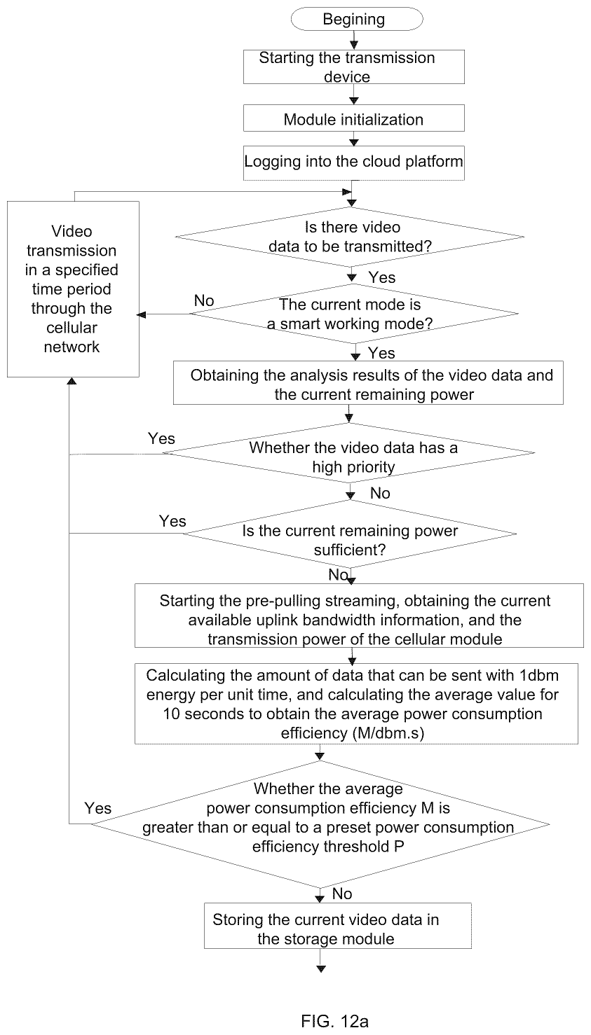

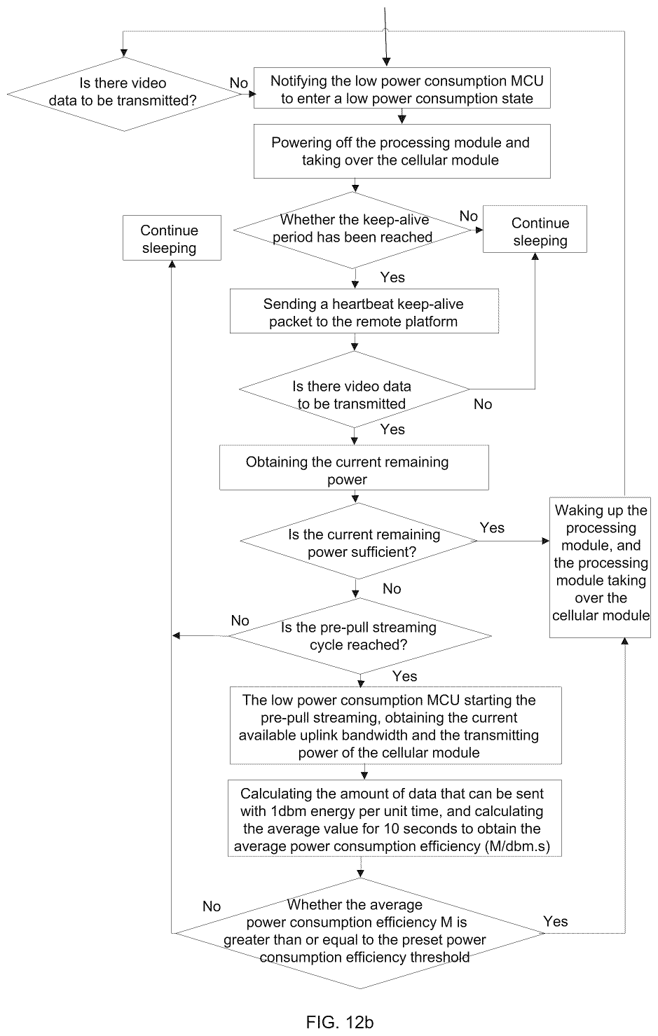

As shown in FIGS. 12a and 12b, the present disclosure may provide a real-time working mode and a smart working mode. Under the real-time working mode, the real-time has the first priority, and the stream pulling (i.e., video data transmission) may be unconditionally started. Under the smart working mode, the transmission device may comprehensively determine whether to start stream pulling based on the current remaining power, the emergency situation of the monitoring scene, and the average power consumption efficiency of the cellular module, or the like, or any combination thereof.

Where the battery power is insufficient and the monitoring scene is not urgent, the transmission of video data may be started only when the power consumption efficiency of the cellular module is high. In other cases, the transmission device may be switched to keep-alive state with low power consumption. The low power consumption MCU may be used to query the battery power and evaluate the power consumption efficiency of the cellular module during the keep-alive period. Only when the battery power is sufficient or the power consumption efficiency of the cellular module is high, the processing module may be awakened again to pull the steam. A trade-off has been made between the real-time and low power consumption, which ensures both real-time performance and power utilization efficiency to a certain extent.

The present disclosure takes full account of the impact of the wireless environment on the power consumption efficiency of the cellular module. When the power is sufficient, the time real is given priority, and when the power isn't very sufficient, the energy utilization efficiency is given priority.

In some embodiments, the low power consumption device may be powered by solar power supply. Such low power consumption device can be used in methods and the systems that take both the real-time and the energy consumption utilization rate into account. In the real-time working mode, the stream pulling may be immediately started. In the smart working mode, the current battery power, the smart video data analysis result and the power consumption efficiency of the cellular module may be considered to determine comprehensively whether the video data has a high-priority (e.g., video data including images showing arson, theft has a high-priority) If the video data has a normal priority, the current battery level may be checked at this time, and if the power level is sufficient, the video data may further be transmitted. If the video data has a normal priority and the battery power is normal or insufficient, then the average power consumption efficiency of the current cellular module may be determined. If the average power consumption efficiency of the current cellular module is high (greater than a preset value), it may indicate that the current network signal is good and the base station resources are sufficient, and there are sufficient wireless resources for the device to perform efficient data transmission. At this time, even if the power of the transmission device is insufficient, the transmission device may send the video data quickly and then enter a low power consumption state. If the battery power is in an extremely low state, the transmission device may only periodically perform maintenance operations with the cloud platform, and may not perform video transmission until it is charged.

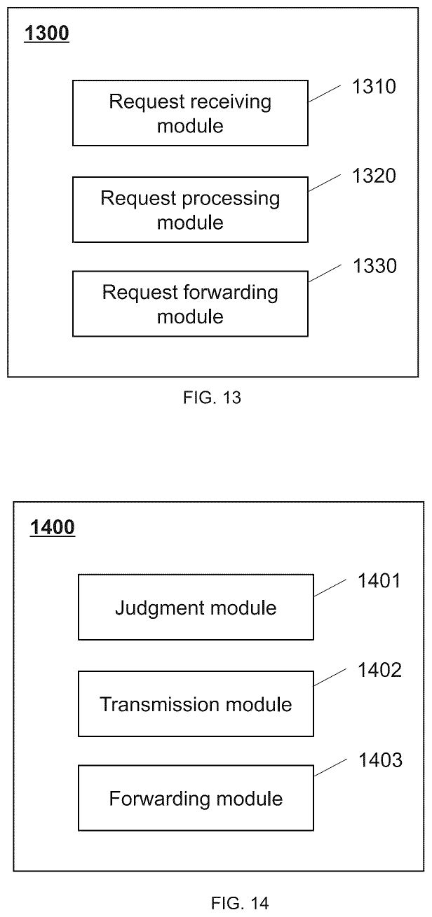

FIG. 13 is an exemplary block diagram illustrating an information transmission device 1300 according to some embodiments of the present disclosure.

As shown in FIG. 13, the information transmission device 1300 may include a request receiving module 1310, a request processing module 1320, and a request forwarding module 1330. In some embodiments, the information transmission device 1300 may be a first type of node or second type of node as discussed above.

The request receiving module 1310 may be configured to control the first type of node to receive a transmission request for requesting a node to perform remote information transmission, and determine whether the node identification in the transmission request matches a preset identification.

In response to determining that the node identification in the transmission request matches a preset identification, the request processing module 1320 may process the transmission request through the first type of node.

In response to determining that the node identification in the transmission request doesn't satisfy the preset identification, the request forwarding module 1330 may forward the transmission request to the second type of node through the first type of node, and process the transmission request through the second type of node.

It should be noted that the above descriptions of the system and its modules are only for the convenience of description, and cannot limit the description to the scope of the embodiments. It can be understood that for those skilled in the art, after understanding the principle of the system, it is possible to combine various modules arbitrarily or form a subsystem to connect with other modules without departing from this principle. For example, in some embodiments, the request receiving module 1310, the request processing module 1320, and the request forwarding module 1330 disclosed in FIG. 13 may be different modules in one system, or one module can realize the functions of the above two or more modules. For example, the request processing module 1320 and the request forwarding module 1330 may be two modules or one module may have both sending and receiving functions. For example, each module may share one storage module, or each module may have its storage module. Such deformations are within the protection scope of the present disclosure.

The present disclosure may further provide an information transmission device 1400 according to some embodiments of the present disclosure. The information transmission device may be used to reduce the power consumed by multiple nodes in high speed remote information transmission. In some embodiments, the information transmission device 1400 may be a first type of node or second type of node as discussed above. As shown in FIG. 14, the device 1400 may include a judgment module 1401, a transmission module 1402, and a forwarding module 1403.

The judgment module 1401 may be configured to receive a transmission request for requesting a node to perform remote information transmission and determine whether a node identification in the transmission request matches a preset identification through a first type of node. Each first type of node and each second type of node may include high power consumption devices in a sleep state and low power consumption devices in a sleep state.

In response to determining that the node identification in the transmission request matches the preset identification, the transmission module 1402 may be configured to switch a high power consumption device of the first type of node to an enabled state and perform information transmission through the high power consumption device of the first type of node.

In response to determining that the node identification in the transmission request doesn't match the preset identification, the forwarding module 1403 may be configured to switch the low power consumption device of the first type of node to the enabled state and transmit the transmission request to the second type of node through the low power consumption device of the first type of node.

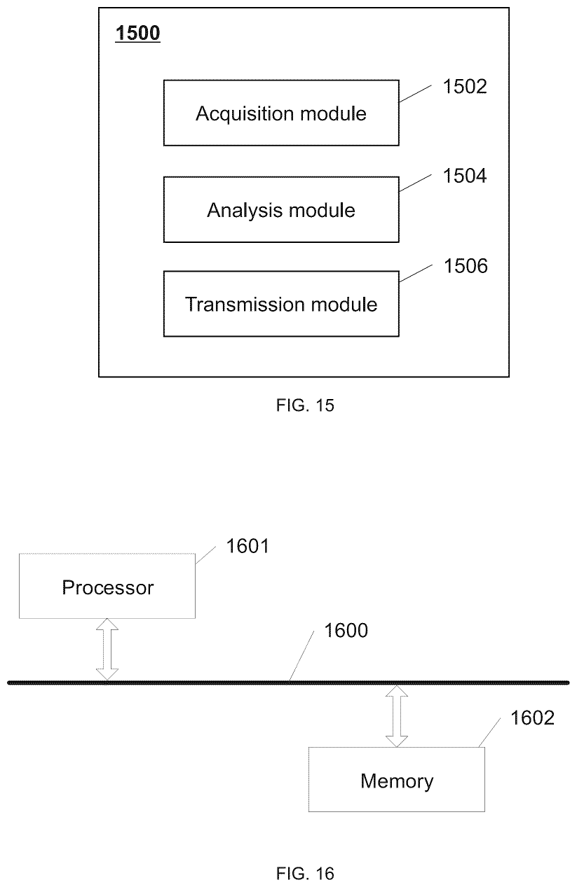

FIG. 15 is an exemplary block diagram illustrating a transmission device 1500 according to some embodiments of the present disclosure. In some embodiments, the information transmission device 1500 may be a first type of node or second type of node as discussed above. As shown in FIG. 15, the transmission device 1500 may include an acquisition module 1502, an analysis module 1504, and a transmission module 1506. The acquisition module 1502 may be configured to obtain the video data to be transmitted and a current remaining power of the transmission device 1500, the video data to be transmitted may be a frame taken by the transmission device 1500. The analysis module 1504 may be configured to obtain an analysis result of the video data by analyzing the video data. The transmission module 1506 may be configured to transmit the video data based on the current remaining power and the analysis result.

In an exemplary embodiment, the above-mentioned transmission device (e.g., the transmission device 1300, or 1400, or 1500) may further be configured to transmit the video data when the analysis result indicates that the video data has a high-priority, and the current remaining power of the transmission device satisfies the condition for transmitting the video data. When the analysis result indicates that the video data has a normal priority, the video data may be transmitted according to the current remaining power of the transmission device.

In an exemplary embodiment, the above-mentioned transmission device may further be configured to transmit the video data when the current remaining power of the transmission device is greater than or equal to a first preset threshold. The video data may be transmitted based on an average power consumption efficiency of a cellular module of the transmission device when the current remaining power of the transmission device is less than the first preset threshold and greater than or equal to a second preset threshold, the average power consumption efficiency is an amount of data transmitted by the cellular module with a unit transmission power in a unit time. The video data may be stored in a storage module when the current remaining power of the transmission device is less than the second preset threshold.

In an exemplary embodiment, the above-mentioned transmission device may further be configured to transmit the video data when the average power consumption efficiency is greater than or equal to a preset power consumption efficiency threshold. When the average power consumption efficiency is less than the preset power consumption efficiency threshold, the video data may be stored in the storage module.

In an exemplary embodiment, the above-mentioned transmission device may further be configured to send a heartbeat command to a remote platform every predetermined period to keep a heartbeat keep-alive with the remote platform after the video data is stored in the storage module. During the heartbeat keep-alive with the remote platform, the transmission device may be charged through a charging module of the transmission device to obtain the current remaining power of the transmission device after charging. The video data may be transmitted based on the current remaining power of the transmission device after charging.

In an exemplary embodiment, the above-mentioned transmission device may further be configured to transmit the video data when the current remaining power of the transmission device after charging is greater than or equal to the first preset threshold. The average power consumption efficiency of the cellular module may be detected when the current remaining power of the transmission device after charging is less than the first preset threshold and a power consumption detection time of the cellular module is reached. The video data may be transmitted when the average power consumption efficiency of the cellular module is greater than or equal to the preset power consumption efficiency threshold.

It should be noted that each of the above-mentioned modules may be realized by software or hardware,. In some embodiments, the above-mentioned modules may be all located in the same processor, or, the above-mentioned modules may be located in multiple processors.

Embodiments of the present disclosure further provide a computer readable storage medium, wherein a computer program is stored in the computer readable storage medium, when the computer program is executed by a processor, information transmission methods described above may be implemented.

In an exemplary embodiment, the above-mentioned computer readable storage medium may include but is not limited to various media that can store computer programs, such as a U disk, a Read Only Memory (ROM), a Random Access Memory (RAM), a mobile hard disk, a magnetic disk or an optical disk and other media that may store computer programs.

An electronic device is provided in the embodiments of the present disclosure, and the electronic device may realize the function of the aforementioned transmission device. As shown in FIG. 16, the electronic device may include at least one processor 1601 and a memory 1602 connected to the at least one processor 1601. The specific connection medium between the processor 1601 and the memory 1602 may not be limited in the embodiments of the present disclosure. For example, as shown in FIG. 16, a bus 1600 may be used to establish a connection between the processor 1601 and the memory 1602. The bus 1600 may include an address bus, a data bus, a control bus, etc., for ease of representation, only one thick line is used in the figure, but it doesn't mean that there is only one bus or one type of bus. Alternatively, the processor 1601 may also be referred to as a controller, and there is no limitation on the name.

In some embodiments of the present disclosure, the memory 1602 stores instructions executable by the at least one processor 1601, and at least one processor 1601 may execute the methods for information transmission discussed above by executing the instructions stored in the memory 1602. The at least one processor 1601 may implement functions of various modules in the device shown in FIGS. 13-15.

The at least one processor 1601 is the control center of the electronic device, and various interfaces and lines may be configured to connect the various parts of the control center, and by running or executing instructions stored in the memory 1602 and calling the data stored in the memory 1602, various functions of the electronic device may be realized.

In a possible design, the at least one processor 1601 may include one or more processing units, and the at least one processor 1601 may include an application processor and a modem processor. The application processor mainly processes an operating system, a user interface, and applications, etc., and the modem processor mainly handles wireless communications. It can be understood that the foregoing modem processor may be integrated into or not be integrated into the processor 1601. In some embodiments, the at least one processor 1601 and the memory 1602 may be implemented on the same chip, and in some embodiments, they may be implemented on independent chips.

The at least one processor 1601 may be a general purpose processor, such as, a central processing unit (CPU), a digital signal processor, an application-specific integrated circuit, a field programmable gate array or other programmable logic devices, discrete gate or transistor logic devices, and discrete hardware components can implement or execute the methods disclosed in the embodiments of the present disclosure, steps and logic block diagram. A general purpose processor may be a microprocessor or any conventional processor, or the like. The steps of the method for information transmission disclosed in the embodiments of the present disclosure may be directly implemented by a hardware processor or implemented by a combination of hardware and software modules in the processor.

The memory 1602, as a non-volatile computer-readable storage medium, may be configured to store non-volatile software programs, non-volatile computer executable programs and modules. The memory 1602 may include at least one type of storage medium, for example, may include flash memory, a hard disk, a multimedia card, a card memory, a random access memory (RAM), a static random access memory (SRAM), a (PROM), Read Only Memory (ROM), an electrically erasable programmable read-only memory (EEPROM), a magnetic memory, a disk, a CD, etc. The memory 1602 may be any other medium that may be configured to carry or store desired program code in the form of instructions or data structures and may be accessed by a computer, but is not limited. The memory 1602 in some embodiments of the present disclosure may further be a circuit or any other device/system capable of implementing a storage function and may be configured to store program instructions and/or data.

By designing and programming the at least one processor 1601, the code corresponding to the methods for information transmission introduced in the foregoing embodiments may be solidified into the chip, so that the chip may be enabled to execute the operations of the method for information transmission of some embodiments shown in FIG. 3 or 6 during operation. How to design and program the processor 1601 is well known to those skilled in the art and may not be repeated.

Based on the same inventive concept, some embodiments of the present disclosure may further provide a storage medium, the storage medium stores computer instructions, and when the computer instructions are run on the computer, the computer may perform the discussed method for information transmission.

It should be noted that the beneficial effects that may be produced by different embodiments are different, and in different embodiments, the beneficial effects that may be produced may be any one of the above or a combination of several, and may further be any other beneficial effect that may be obtained.

Having thus described the basic concepts, it may be rather apparent to those skilled in the art after reading this detailed disclosure that the foregoing detailed disclosure is intended to be presented by way of example only and isn't limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been configured to describe embodiments of the present disclosure. For example, the terms “one embodiment,” “an embodiment,” and/or “some embodiments” mean that a particular feature, structure, or feature described in connection with some embodiments is included in at least one embodiment of the present disclosure. Therefore, it is emphasized and should be appreciated that two or more references to “an embodiment,” “one embodiment,” or “an alternative embodiment” in various portions of the present disclosure are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations, therefore, isn't intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may further be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure and aiding in the understanding of one or more of the various embodiments. This method of disclosure, however, isn't to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties configured to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for information transmission, comprising:
receiving a transmission request for requesting a node to perform remote information transmission and determining whether a node identification in the transmission request matches a preset identification through a first type of node;
in response to determining that the node identification in the transmission request matches the preset identification, processing the transmission request through the first type of node; and
in response to determining that the node identification in the transmission request doesn't match the preset identification, forwarding the transmission request to a second type of node through the first type of node, and processing the transmission request through the second type of node.

2. The method of claim 1, wherein each of the first type of node and the second type of node comprises a high power consumption device in a sleep state and a low power consumption device in a sleep state;
in response to determining that the node identification in the transmission request matches the preset identification, the processing the transmission request through the first type of node comprises: switching the high power consumption device of the first type of node to an enabled state, and performing the information transmission through the high power consumption device of the first type of node; and
in response to determining that the node identification in the transmission request doesn't match the preset identification, the forwarding the transmission request to a second type of node through the first type of node comprises: switching the low power consumption device of the first type of node to an enabled state, and forwarding the transmission request to the second type of node through the low power consumption device of the first type of node.

3. The method of claim 2, wherein the high power consumption device of the first type of node is in a first sleep state, and the low power consumption device of the first type of node is in a second sleep state;
the high power consumption device of the second type of node is in the second sleep state, and the low power consumption device of the second type of node is in the first sleep state;
wherein a power consumption of each device in the first sleep state is higher than a power consumption in the second sleep state.

4. The method of claim 3, wherein before the first type of node receives the transmission request, the method further comprises:
enabling the low power consumption device of the first type of node to receive one or more response messages sent by the second type of node based on a preset rule, wherein the first type of node and the second type of node are nodes in a specified area; and
in response to determining that an amount of the received one or more response messages and a power consumption of the low power consumption device of the first type of node satisfy a preset condition, switching the low power consumption device of the first type of node to the second sleep state.

5. The method of claim 4, wherein the enabling the low power consumption device of the first type of node to receive one or more response messages sent by the second type of node based on a preset rule comprises:
enabling the low power consumption device of the first type of node based on a sequence including power consumptions of the low power consumption device from small to large; and
receiving the one or more response messages sent by the second type of node through the low power consumption device of the first type of node.

6. The method of claim 4, wherein the determining that an amount of the received one or more response messages and a power consumption of the low power consumption device of the first type of node satisfy a preset condition comprises:
receiving one or more response messages sent by each node in the specified area through the low power consumption device of the first type of node; and
in response to determining that the power consumption of the low power consumption device of the first type of node is less than the power consumption of the low power consumption device of a competing node, determining that the preset condition is satisfied, wherein the competing node is a second type of node that receives the one or more response messages sent by each node in the specified area.

7. The method of claim 4, wherein the determining that an amount of the received one or more response messages and a power consumption of the low power consumption device of the first type of node satisfy a preset condition comprises:
enabling a highest transmission power of the low power consumption device of the first type of node, and receiving the one or more response messages through the low power consumption device with the highest transmission power, and determining a first amount of the received one or more response messages;
for each second type of node, obtaining a second amount of one or more response messages received by the second type of node by enabling the low power consumption device of the second type of node with the highest transmission power; and
in response to determining that the first amount is greater than the second amount of each second type of node, determining that the preset condition is satisfied.

8. The method of claim 2, wherein the first type of node and the second type of node are nodes in a specified area,
the first type of node comprises a plurality of first type of nodes,
each of the plurality of first type of nodes is configured to receive the one or more response messages sent by each second type of node through their respective low power consumption devices; and,
a total power consumption of the lower power consumption devices of the plurality of first type of nodes is minimized.

9. The method of claim 1, wherein the transmission request is configured to transmit video data;
each of the first type of node and the second type of node includes a transmission device, and the processing the transmission request comprises:
obtaining the video data to be transmitted and a current remaining power of the transmission device, wherein the video data to be transmitted includes a frame taken by the transmission device;
obtaining an analysis result of the video data by analyzing the video data through the transmission device; and
transmitting the video data based on the current remaining power and the analysis result.

10. The method of claim 9, wherein the transmitting the video data based on the current remaining power and the analysis result comprises:
transmitting the video data when the analysis result indicates that the video data has a high-priority, and the current remaining power of the transmission device satisfies the condition for transmitting the video data; or
transmitting the video data based on the current remaining power of the transmission device when the analysis result indicates that the video data has a normal priority.

11. The method of claim 10, wherein the transmitting the video data based on the current remaining power of the transmission device comprises:
transmitting the video data when the current remaining power of the transmission device is greater than or equal to a first preset threshold; or
transmitting the video data based on an average power consumption efficiency of a cellular module of the transmission device when the current remaining power of the transmission device is less than the first preset threshold and greater than or equal to a second preset threshold, wherein the average power consumption efficiency is an amount of data transmitted by the cellular module with a unit transmission power in a unit time; or
storing the video data in a storage module when the current remaining power of the transmission device is less than the second preset threshold.

12. The method of claim 11, wherein the transmitting the video data based on an average power consumption efficiency of a cellular module in the transmission device comprises:
transmitting the video data when the average power consumption efficiency is greater than or equal to a preset power consumption efficiency threshold; or
storing the video data in the storage module when the average power consumption efficiency is less than the preset power consumption efficiency threshold.

13. The method of claim 11, wherein after storing the video data in the storage module, the method further comprises:
sending a heartbeat command to a remote platform every predetermined period to keep a heartbeat keep-alive with the remote platform;
during the heartbeat keep-alive with the remote platform, charging the transmission device through a charging module of the transmission device to obtain the current remaining power of the transmission device after charging; and
transmitting the video data based on the current remaining power of the transmission device after charging.

14. The method of claim 13, wherein the transmitting the video data based on the current remaining power of the transmission device after charging comprises:
transmitting the video data when the current remaining power of the transmission device after charging is greater than or equal to the first preset threshold; or
detecting the average power consumption efficiency of the cellular module when the current remaining power of the transmission device after charging is less than the first preset threshold and a power consumption detection time of the cellular module is reached; and
transmitting the video data when the average power consumption efficiency of the cellular module is greater than or equal to the preset power consumption efficiency threshold.

15. The method of claim 9, wherein the transmitting the video data based on the current remaining power and the analysis result comprises:
transmitting a key frame image of the video data when the analysis result indicates that the video data has a high-priority, and the current remaining power of the transmission device doesn't satisfy the condition for transmitting the video data but satisfies the condition for transmitting the key frame image.

16. The method of claim 9, wherein the transmitting the video data based on the current remaining power and the analysis result comprises:
transmitting the video data to a capable node through a low power consumption device when the analysis result indicates that the video data has a high-priority, and the current remaining power of the transmission device doesn't satisfy the condition for transmitting the video data.

17. The method of claim 16, wherein the capable node is identified based on its average power consumption and remaining power.

18. A system for information transmission, comprising:
at least one storage medium including a set of instructions; and
at least one processor in communication with the at least one storage medium, wherein when executing the set of instructions, the at least one processor is directed to cause the system to:
receiving a transmission request for requesting a node to perform remote information transmission and determining whether a node identification in the transmission request matches a preset identification through a first type of node;
in response to determining that the node identification in the transmission request matches the preset identification, processing the transmission request through the first type of node; and
in response to determining that the node identification in the transmission request doesn't match the preset identification, forwarding the transmission request to a second type of node through the first type of node, and processing the transmission request through the second type of node.

19. The system of claim 1, wherein each of the first type of node and the second type of node comprises a high power consumption device in a sleep state and a low power consumption device in a sleep state;
in response to determining that the node identification in the transmission request matches the preset identification, the processing the transmission request through the first type of node comprises: switching the high power consumption device of the first type of node to an enabled state, and performing the information transmission through the high power consumption device of the first type of node; and
in response to determining that the node identification in the transmission request doesn't match the preset identification, the forwarding the transmission request to a second type of node through the first type of node comprises: switching the low power consumption device of the first type of node to an enabled state, and forwarding the transmission request to the second type of node through the low power consumption device of the first type of node.

20. A computer-readable storage medium storing computer programs, wherein the computer programs are executed by a processor to:
receiving a transmission request for requesting a node to perform remote information transmission and determining whether a node identification in the transmission request matches a preset identification through a first type of node;
in response to determining that the node identification in the transmission request matches the preset identification, processing the transmission request through the first type of node; and
in response to determining that the node identification in the transmission request doesn't match the preset identification, forwarding the transmission request to a second type of node through the first type of node, and processing the transmission request through the second type of node.
